(19) United States
(12) Patent Application Publication
(10) Pub. No.: US 2021/0156250 A1
(43) Pub. Date: May 27, 2021

(54) Advance and Retreat Automatic Control Method Based on Hydraulic Sensing Conversion and Advance and Retreat Automatic Control System Based on Hydraulic Sensing Conversion

(71) Applicant: Suhua LIU, Jining,Shandong (CN)

(72) Inventor: Suhua LIU, Jining,Shandong (CN)

(21) Appl. No.: 16/625,767

(22) PCT Filed: Jun. 26, 2018
(86) PCT No.: PCT/CN2018/092753

§ 371 Date: Dec. 23, 2019

(30) Foreign Application Priority Data
Jun. 26, 2017 (CN) 201710496732.8
Jul. 21, 2017 (CN) 201710602610.2
Nov. 6, 2017 (CN) 201711080652.0

(51) Int. Cl. E21C 31/02; E21C 27/28; E21C 29/00; F15B 1/02; F15B 1/033; F15B 11/16

(52) U.S. Cl. CPC E21C 31/02; E21C 27/28; E21C 29/00; F15B 2211/3053; F15B 1/033; F15B 11/165; F15B 11/167; F15B 1/024

(57) ABSTRACT

Some embodiments of the disclosure provide an advance and retreat automatic control method based on hydraulic sensing conversion and an advance and retreat automatic control system based on hydraulic sensing conversion, which includes an automatic advance and retreat device based on hydraulic sensing conversion, a motor, an oil cylinder, and/or an electric generator. When the digging motor encountered an overlarge resistance force, a pressure on the digging motor is instantaneously increased and exceeds a setting pressure value, hydraulic oil enters a hydraulic operated directional valve and pushes a valve rod to make the walking motor is reverse and retreat, an ultrahigh pressure state of the digging motor is released to restore to a normal pressure value to make reciprocated impact, the valve rod of the hydraulic operated directional valve is reset, and the walking motor is forwards rotated for advancing.

### TECHNICAL FIELD

The disclosure relates to a field of machinery, and in particular, to an advance and retreat automatic control method based on hydraulic sensing conversion and an advance and retreat automatic control system based on hydraulic sensing conversion.

### BACKGROUND

Related digger and excavator mining unit are capable of achieving rapid mining and digging by using a reciprocated impact mining and digging mode and/or using a telescopic oil cylinder mining and digging mode, the efficiency of mining and digging a material is high, but a mining head and a digging head frequently cause a mining power generator or motor to be stopped or even damaged by overload because of mining and digging a harder material, especially a reciprocated impact digger and a reciprocated impact excavator, which are high in block material rate, and capable of mining and digging the hard material above F4, so the reciprocated impact digger and the reciprocated impact excavator are the most advanced, scientific and practical mining and digging equipment, however, because the reciprocated impact digger and the reciprocated impact excavator are sometimes stopped while impact teeth are pushed against a material wall, the mining and digging motor and a walking motor are burned by the overload, in order to solve a problem that the motor is burned due to the overload, walking power and reciprocated impact power of the reciprocated impact digger and the reciprocated impact digging machine are changed into hydraulic motor drive or telescopic oil cylinder drive, but the mining head and the digging head of the hydraulic motor drive or the telescopic oil cylinder drive often push against the material wall so as to cause a transient overpressure, so that the motor and the oil cylinder are stopped, the motor and the oil cylinder cause a component sealing element and the like to be deformed due to the overpressure and a high temperature, and even damaged while the material mined and dug by the machine is very less in dust and low in energy consumption, the motor and the oil cylinder may be damaged by the frequent overpressure and stoppage, and unnecessary damage to a hydraulic system may be caused by restarting the motor and the oil cylinder, time and manpower and material resources are wasted, the production efficiency is seriously reduced, and the development of energy-saving and environmental protection values of the reciprocated impact digger and the reciprocated impact excavator is seriously hindered; a cutting and blanking part of an related rolling and milling digger for a mine is capable of adopting the motor power and enabling a cutting roller to rotate and mill blanks through gear transmission, while hard coal and gangue above F4 are encountered, because a rotation cutting motor is increased in torque and operated in overload, the motor is frequently burned to cause suspend production, and because while the motor is used for driving a cutting part to rotate and cut the material, in order to protect cutting teeth from being damaged, a rotation speed of the cutting roller is reduced to a speed which does not exceed 45 revolutions per minute, and a rotation speed of the motor is about 1500 revolutions per minute, the rotation speed is step-by-step reduced to the speed which does not exceed 45 revolutions per minute through a transmission gear, in order to save space, the rolling and milling digger is capable of using a rocker arm as a gear transmission box for transmitting power to the rotation roller, this causes the rocker arm to be huge so as to block conveying space of the coal, and reduce the efficiency of conveying the coal, and because the rocker arm transmits the power through the gear, while the power is transmitted to the rotation roller, it must be ensured that a power shaft of the rotation roller is parallel to a power shaft of the gear of a rocker arm gear box, so it is caused that a size of a connecting part of the rocker arm and the rotation roller is overlarge, the manufacturing cost is high and coal conveying space of a scraper conveyer is blocked by the connecting part of the rocker arm and the roller.

### SUMMARY

Some embodiments of the present disclosure provide an advance and retreat automatic control method based on hydraulic sensing conversion, the advance and retreat automatic control method includes one, an advance and retreat automatic device based on hydraulic sensing conversion is installed, the advance and retreat automatic device based on the hydraulic sensing conversion is enabled to be formed by a hydraulic operated directional valve and the like, or the advance and retreat automatic device based on the hydraulic sensing conversion is enabled to be formed by a sequence valve and a hydraulic operated directional valve and the like, or the advance and retreat automatic device based on the hydraulic sensing conversion is enabled to be formed by a sequence valve, a pressure reducing valve and a hydraulic operated directional valve and the like, or the advance and retreat automatic device based on the hydraulic sensing conversion is enabled to be formed by an energy accumulator, a sequence valve and a hydraulic operated directional valve and the like, or the advance and retreat automatic device based on the hydraulic sensing conversion is enabled to be formed by an energy accumulator, a sequence valve, a pressure reducing valve and a hydraulic operated directional valve and the like; two, the advance and retreat automatic device based on the hydraulic sensing conversion is enabled to be cooperated with a digging motor and a walking motor and the like so as to form a motor advance and retreat automatic mechanism based on hydraulic sensing conversion, or the advance and retreat automatic device based on the hydraulic sensing conversion is enabled to be cooperated with a digging motor and the rocker arm oil cylinder and the like so as to form an oil cylinder automatic telescopic mechanism based on reciprocated impact hydraulic sensing conversion, or the advance and retreat automatic device based on the hydraulic sensing conversion is enabled to be cooperated with a digging oil cylinder and the rocker arm oil cylinder and the like so as to form an oil cylinder automatic telescopic mechanism based on digging hydraulic sensing conversion, a pressure value of the motor advance and retreat automatic device based on the hydraulic sensing conversion is enabled to be less than a pressure value of an overpressure state of the digging motor, or a pressure value of the oil cylinder automatic telescopic device based on the reciprocated impact hydraulic sensing conversion is enabled to be less than a pressure value of the overpressure state of the digging motor, or a pressure value of the oil cylinder automatic telescopic device based on the digging hydraulic sensing conversion is enabled to be less than a pressure value of an overpressure state of the digging oil cylinder; three, while the digging motor encounters with an overlarge resistance, a pressure of the digging motor is instantly increased to exceed a setting pressure value, hydraulic oil enters the hydraulic operated directional valve, a valve rod is pushed so that the walking motor is reversely rotated, an ultrahigh pressure state of the digging motor is released to restore a normal pressure value for the reciprocated impact, and the valve rod of the hydraulic operated directional valve is reset, so the walking motor is forwards rotated for advancing; or while the digging motor encounters with an overlarge resistance, a pressure of the digging motor is instantly increased to exceed a setting pressure value, the hydraulic oil enters the hydraulic operated directional valve through the sequence valve, the valve rod is pushed so that the walking motor is reversely rotated, an ultrahigh pressure state of the digging motor is released to restore a normal pressure value for the reciprocated impact, the walking motor is forwards rotated for advancing, and the sequence valve is cooperated with the hydraulic operated directional valve to ensure precision of retreat and advance restoration of the walking motor; or while the digging motor encounters with an overlarge resistance, a pressure of the digging motor is instantly increased to exceed a setting pressure value, hydraulic oil enters the hydraulic operated directional valve through the sequence valve and the pressure reducing valve, the valve rod is pushed so that the hydraulic oil enters a retreat cavity of the rocker arm oil cylinder, and a cylinder rod is retreated, an ultrahigh pressure state of the digging motor is released to restore a normal pressure value for the reciprocated impact, the sequence valve and the pressure reducing valve are cooperated with the hydraulic operated directional valve and the like so as to ensure precision of retreat and advance restoration of the rocker arm oil cylinder, and ensure that retreat speed and distance of the cylinder rod are adjustable while the rocker arm oil cylinder encounters with an overpressure state; or while the digging motor encounters with an overlarge resistance, a pressure of the digging motor is instantly increased to exceed a setting pressure value, the hydraulic oil enters the hydraulic operated directional valve through the energy accumulator, the sequence valve and the pressure reducing valve, the valve rod is pushed so that hydraulic oil enables the walking motor to be reversely rotated, an ultrahigh state of the digging motor is enabled to be released, the walking motor is enabled to be forwards rotated for advancing, and the energy accumulator, the sequence valve and the pressure reducing valve are enabled to be cooperated with the hydraulic operated directional valve and the like so as to ensure speed and precision of retreat and advance restoration of the rocker arm oil cylinder, and ensure that retreat speed and distance of the cylinder rod are adjustable while the rocker arm oil cylinder encounters with an overpressure state.

In an exemplary embodiment, the advance and retreat automatic control method based on the hydraulic sensing conversion further includes the following steps: according to hardness of the material which needs to be dug, a normal digging pressure value of the digging motor is determined, and a pressure value of the walking motor is adjusted so that it is matched with the normal digging pressure value of the digging motor, while a pressure value of the digging motor needs to be improved when the hard material is impacted, a pressure value of an advance and retreat automatic device system based on hydraulic sensing conversion is improved so that it is matched with the pressure value of the digging motor, while the digging motor digs an excessive hard material, a pressure of the digging motor exceeds a setting pressure value, the motor advance and retreat automatic mechanism based on the hydraulic sensing conversion is capable of enabling the walking motor to be reversely rotated for retreating, the digging motor dose not damage a digging part component because of the digging motor is not stopped by the overpressure due to digging the excessive hard material, sensing the hardness of the dug material is achieved by the motor advance and retreat automatic mechanism based on the hydraulic sensing conversion and a digging part is protected in advance, or according to the hardness of the material which needs to be dug, the normal digging pressure value of the digging motor is determined, the pressure value of the rocker arm oil cylinder is enabled to be matched with a normal digging pressure value of the digging motor, while the digging motor digs the excessive hard material, the pressure value of the digging motor is instantly increased to exceed the setting pressure value, the oil cylinder automatic telescopic mechanism based on the hydraulic sensing conversion is capable of enabling the rocker arm oil cylinder to be retreated, the digging motor dose not damage a digging part component because of the digging motor is not stopped by the overpressure due to digging the excessive hard material, sensing the hardness of the dug material is achieved by the oil cylinder automatic telescopic mechanism based on the hydraulic sensing conversion and the digging part is protected in advance; or according to the hardness of the material which needs to be dug, a normal digging current value of the digging generator is determined, a pressure value of the walking motor is enabled to be matched with a normal digging current value of the digging generator, while the digging generator digs the excessive hard material, a pressure of the walking motor is instantly increased to exceed the setting pressure value, the advance and retreat automatic device based on the hydraulic sensing conversion is capable of enabling the walking motor to be reversely rotated for retreating, while the digging generator digs the excessive hard material, a current is improved and the digging generator is not stopped by the overload, the walking motor is instantly reversely rotated for retreating, and the digging generator dose not damage a digging part component because of the digging generator is not stopped by the overload due to digging the excessive hard material, sensing the hardness of the dug material is achieved by the advance and retreat automatic device based on the hydraulic sensing conversion and the digging part is protected in advance.

In an exemplary embodiment, the advance and retreat automatic control system based on hydraulic sensing conversion for achieving the advance and retreat automatic control method based on the hydraulic sensing conversion includes the advance and retreat automatic control system based on the hydraulic sensing conversion which includes an advance and retreat automatic device based on hydraulic sensing conversion and the like, the advance and retreat automatic control system based on the hydraulic sensing conversion further includes a motor, an oil cylinder and/or an electric generator and the like, the advance and retreat automatic device based on the hydraulic sensing conversion includes a hydraulic operated directional valve and the like, or the advance and retreat automatic device based on the hydraulic sensing conversion includes a sequence valve and a hydraulic operated directional valve and the like, or the advance and retreat automatic device based on the hydraulic sensing conversion includes a sequence valve, a pressure reducing valve and a hydraulic operated directional valve and the like, or the advance and retreat automatic device based on the hydraulic sensing conversion includes an energy accumulator, a sequence valve and the hydraulic operated directional valve and the like, or the advance and retreat automatic device based on the hydraulic sensing conversion includes an energy accumulator, a sequence valve, a pressure reducing valve and a hydraulic operated directional valve and the like, the motor includes a digging motor and/or a walking motor and the like, the oil cylinder includes a rocker arm oil cylinder and/or a digging oil cylinder and the like, the advance and retreat automatic device based on the hydraulic sensing conversion is cooperated with a digging motor and a walking motor and the like so as to form a motor advance and retreat automatic mechanism based on hydraulic sensing conversion, or the advance and retreat automatic device based on the hydraulic sensing conversion is cooperated with the digging motor and the rocker arm oil cylinder and the like so as to form an oil cylinder automatic telescopic mechanism based on reciprocated impact hydraulic sensing conversion, or the advance and retreat automatic device based on the hydraulic sensing conversion is cooperated with a digging oil cylinder and a rocker arm oil cylinder and the like so as to form an oil cylinder automatic telescopic mechanism based on digging hydraulic sensing conversion, the pressure of the motor advance and retreat automatic device based on the hydraulic sensing conversion is less than the pressure value of the overpressure state of the digging motor, or the pressure of the oil cylinder automatic telescopic device based on the reciprocated impact hydraulic sensing conversion is less than the pressure value of the overpressure state of the digging motor, or the pressure of the oil cylinder automatic telescopic device based on the digging hydraulic sensing conversion is less than the pressure value of the overpressure state of the digging oil cylinder, while the digging motor encounters with the overlarge resistance, the pressure of the digging motor is instantly increased to exceed the setting pressure value, the hydraulic oil enters the hydraulic operated directional valve, the valve rod is pushed so that the walking motor is reversely rotated, the ultrahigh pressure state of the digging motor is released to restore the normal pressure value for the reciprocated impact, and the valve rod of the hydraulic operated directional valve is reset, so the walking motor is forwards rotated for advancing, or while the digging motor encounters with the overlarge resistance, the pressure of the digging motor is instantly increased to exceed the setting pressure value, the hydraulic oil enters the hydraulic operated directional valve through the sequence valve, the valve rod is pushed so that the walking motor is reversely rotated for retreating, the ultrahigh pressure state of the digging motor is released to restore the normal pressure value for the reciprocated impact, the walking motor is forwards rotated for advancing, and the sequence valve is cooperated with the hydraulic operated directional valve and the like to ensure the precision of retreat and advance restoration of the walking motor, or while the digging motor encounters with the overlarge resistance, the pressure of the digging motor is instantly increased to exceed the setting pressure value, the hydraulic oil enters the hydraulic operated directional valve through the sequence valve and the pressure reducing valve, the valve rod is pushed so that the hydraulic oil enters the retreat cavity of the rocker arm oil cylinder, and the cylinder rod is retreated, the ultrahigh pressure state of the digging motor is released to restore the normal pressure value for the reciprocated impact, the sequence valve and the pressure reducing valve are cooperated with the hydraulic operated directional valve and the like so as to ensure the precision of retreat and advance restoration of the rocker arm oil cylinder, and ensure that the retreat speed and distance of the cylinder rod are adjustable while the rocker arm oil cylinder encounters with the overpressure state, or while the digging motor encounters with the overlarge resistance, the pressure of the digging motor is instantly increased to exceed the setting pressure value, the hydraulic oil enters the hydraulic operated directional valve through the energy accumulator, the sequence valve and the pressure reducing valve, the valve rod is pushed so that the hydraulic oil enables the walking motor to be reversely rotated, the ultrahigh state of the digging motor is released so that the walking motor is forwards rotated for advancing, and the energy accumulator, the sequence valve and the pressure reducing valve are cooperated with the hydraulic operated directional valve and the like so as to ensure the speed and the precision of retreat and advance restoration of the rocker arm oil cylinder, and ensure that the retreat speed and distance of the cylinder rod are adjustable while the rocker arm oil cylinder encounters with the overpressure state.

In an exemplary embodiment, according to the hardness of the material which needs to be dug, a normal digging pressure value of the digging motor is determined, and a pressure value of the walking motor is adjusted so that it is matched with the normal digging pressure value of the digging motor, while the pressure value of the digging motor needs to be improved when the hard material is impacted, a pressure value of the advance and retreat automatic device system based on the hydraulic sensing conversion is improved so that it is matched with a pressure value of the digging motor, while the digging motor digs the excessive hard material, and the pressure of the digging motor exceeds the setting pressure value, the motor advance and retreat automatic mechanism based on the hydraulic sensing conversion is capable of enabling the walking motor to be reversely rotated for retreating, the digging motor dose not damage a digging part component because of the the digging motor is not stopped by the overpressure due to digging the excessive hard material, sensing the hardness of the dug material is achieved by the motor advance and retreat automatic mechanism based on the hydraulic sensing conversion and a digging part is protected in advance; or according to the hardness of the material which needs to be dug, a normal digging pressure value of the digging motor is determined, a pressure value of the rocker arm oil cylinder is enabled to be matched with the normal digging pressure value of the digging motor, while the digging motor digs the excessive hard material, the pressure value of the digging motor is instantly increased to exceed the setting pressure value, the oil cylinder automatic telescopic mechanism based on the hydraulic sensing conversion is capable of enabling the rocker arm oil cylinder to be retreated, the digging motor dose not damaging a digging part component because of the digging motor is not stopped by the overpressure due to digging the excessive hard material, sensing the hardness of the dug material is achieved by the oil cylinder automatic telescopic mechanism based on the hydraulic sensing conversion and a digging part is protected in advance, or according to the hardness of the material which needs to be dug, a normal digging current value of the digging generator is determined, a pressure value of the walking motor is enabled to be matched with the normal digging current value of the digging generator, while the digging generator digs the excessive hard material, the pressure of the walking motor is instantly increased to exceed the setting pressure value, the advance and retreat automatic device based on the hydraulic sensing conversion is capable of enabling the walking motor to be reversely rotated for retreating, while the digging generator digs the excessive hard material, the current is improved and the digging generator is not stopped by the overload, the walking motor is instantly reversely rotated for retreating, and the digging generator dose not damage a digging part component because of the digging generator is not stopped by the overload due to digging the excessive hard material, sensing the hardness of the dug material is achieved by the advance and retreat automatic device based on the hydraulic sensing conversion and a digging part is protected in advance.

In an exemplary embodiment, the advance and retreat automatic control system based on the hydraulic sensing conversion includes a machine body and the digging part, the advance and retreat automatic control system based on the hydraulic sensing conversion includes a hydraulic box, a hydraulic pump and a pump motor and the like disposed on the machine body, the hydraulic box, the hydraulic pump and the pump motor and the like form a machine body power part, one end or two ends of the machine body are provided with the digging part and the like, the hydraulic pump absorbs liquid which is converted into a power source, the digging part includes the digging motor or the digging oil cylinder or the digging generator and the like, the machine body includes a walking bracket and the like, the walking bracket is provided with a walking motor or a walking generator and the like, the machine body includes a fixed long-arm machine body or a telescopic arm machine body or a directly connected digging part machine body and the like, the telescopic arm machine body includes a telescopic rocker arm and the like, the telescopic rocker arm includes the rocker arm oil cylinder and the like, the rocker arm oil cylinder includes a rocker arm telescopic oil cylinder and/or a rocker arm swing oil cylinder and the like, the advance and retreat automatic device based on the hydraulic sensing conversion is installed on the telescopic rocker arm or installed on the machine body or installed on the digging part, a front end of the telescopic rocker arm is provided with a digging head and the like, the advance and retreat automatic device based on the hydraulic sensing conversion controls the rocker arm oil cylinder or controls the walking motor, while a force of the telescopic rocker arm stretched out and pushed against the material is greater than a stretching force of the rocker arm oil cylinder and the overpressure occurs, the advance and retreat automatic device based on the hydraulic sensing conversion is capable of enabling the hydraulic oil to be flowed into a backward retreat cavity of the rocker arm oil cylinder, and enabling the telescopic rocker arm to be backwards retreated, at this moment, the overpressure in a forward advance cavity is released, the hydraulic oil is shifted into the forward advance cavity and the telescopic rocker arm is forwards stretched out, or while a force of the machine body which is forwards advanced and pushed against the material is greater than a force of the walking motor and the overpressure occurs, the advance and retreat automatic device based on the hydraulic sensing conversion controls the walking motor to be backwards retreated, the overpressure is released, and the walking motor is forwards advanced, or according to the hardness of the material which needs to be dug, the normal digging pressure value of the digging motor is determined, the pressure value of the rocker arm oil cylinder is enabled to be matched with the normal digging pressure value of the digging motor, while the digging motor digs the excessive hard material and the pressure value of the digging motor is in the overpressure, the oil cylinder automatic telescopic mechanism based on the hydraulic sensing conversion is capable of enabling the rocker arm swing oil cylinder to be retreated, the digging motor is not dose not damage a digging part component because of the digging motor stopped by the overpressure due to digging the excessive hard material, sensing the hardness of the dug material is achieved by the oil cylinder automatic telescopic mechanism based on the hydraulic sensing conversion and the digging part is protected in advance.

In an exemplary embodiment, the advance and retreat automatic device based on the hydraulic sensing conversion includes a pressurizer or the energy accumulator and the like, while the pressurizer is used, the pressurizer is installed on a pump output pipeline or installed on a motor oil inlet pipeline or installed on a hydraulic cylinder oil inlet pipeline or installed on the advance and retreat automatic device based on the hydraulic sensing conversion and the like, or while the energy accumulator is used, the energy accumulator is installed on a pump output pipeline or installed on a motor oil inlet pipeline or installed on a hydraulic cylinder oil inlet pipeline or installed on the advance and retreat automatic device based on the hydraulic sensing conversion and the like.

In an exemplary embodiment, the machine body is in fixed connection or slide connection and the like with the digging part, the machine body includes a fixed digging part structure or a machine body lifting digging part structure and the like, the digging part includes a digging part suspension machine body fixing structure or a digging part suspension machine body lifting structure and the like, the machine body fixed digging part structure is buttoned on the digging part suspension machine body fixing structure, the machine body lifting digging part structure is cooperated with the digging part suspension machine body lifting structure and the like, the machine body fixed digging part structure or the machine body lifting digging part structure is provided with a straight sliding rail, and the corresponding digging part suspension machine body fixing structure or digging part suspension machine body lifting structure is provided with a straight sliding chute and the like, the straight sliding rail is buttoned with the straight sliding chute so that the digging part is connected with the machine body; or the machine body fixed digging part structure or the machine body lifting digging part structure includes a small-upper large-lower wedge-shaped sliding rail and the corresponding digging part suspension machine body fixing structure or digging part suspension machine body lifting structure includes a small-upper large-lower wedge-shaped sliding chute and the like, the small-upper large-lower wedge-shaped sliding chute is buttoned with the small-upper large-lower wedge-shaped sliding rail, under an effect of gravity of the digging part, the small-upper large-lower wedge-shaped sliding chute is closely buttoned on the small-upper large-lower wedge-shaped sliding rail, the digging part is firmly suspended on the machine body without an auxiliary component so as to increase shock strength, or the machine body lifting digging part structure is installed on an end face of the machine body towards a coal wall to be mined or installed on a front part of the machine body and the like, the corresponding digging part suspension machine body lifting structure is installed on an end face of the digging part towards the machine body or installed on the front part of the machine body and the like, or while the slide connection of the machine body and the digging part is used, the machine body is slidably buttoned with the digging part and the digging part is lifted by an external force, the machine body lifting digging part structure includes a tension digging part suspension machine body lifting structure pin column hole and a tension digging part suspension machine body lifting structure pin column and the like, the tension digging part suspension machine body lifting structure pin column includes a T-type pin column or a straight pin fixed sleeve column and the like, while the T-type pin column is used, a lower part of the T-type pin column is inserted in the tension digging part suspension machine body lifting structure pin column hole, and an upper part of the T-type pin column is buttoned with the digging part suspension machine body lifting structure, or while the straight pin fixed sleeve column is used, the straight pin fixed sleeve column includes a sliding rail inserting hole column and a tension digging part fixed sleeve and the like, a lower part of the sliding rail inserting hole column is inserted in the tension digging part suspension machine body lifting structure pin column hole, and an upper part of the sliding rail inserting hole column is buttoned with the tension digging part fixed sleeve so that an exterior of the tension digging part fixed sleeve is buttoned with the digging part suspension machine body lifting structure, the tension digging part suspension machine body lifting structure pin column hole supports and fixes the sliding rail inserting hole column, the sliding rail inserting hole column fixes the tension digging fixed sleeve, the digging part suspension machine body lifting structure tightly holds the sliding rail inserting hole column through the tension digging part fixed sleeve, the fixing strength of the digging part and the machine body is increased, or the machine body is provided with a lifting digging part hydraulic cylinder and the like, the digging part suspension machine body lifting structure is buttoned with the machine body lifting digging part structure so that the digging part is suspended on the machine body, while the digging part needs to be ascended, the lifting digging part hydraulic cylinder is capable of enabling the digging part suspension machine body lifting structure to be upwards slid to a required height for positioning along the machine body lifting digging part structure, or while the small-upper large-lower wedge-shaped sliding rail and the small-upper large-lower wedge-shaped sliding chute are used for lifting the digging part, the small-upper large-lower wedge-shaped sliding chute is firstly ascended, according to a position which needs to be ascended, an adjusting fixed cushion is installed in the small-upper large-lower wedge-shaped sliding chute, the adjusting fixed cushion is disposed between the small-upper large-lower wedge-shaped sliding rail and the small-upper large-lower wedge-shaped sliding chute so as to prevent the small-upper large-lower wedge-shaped sliding chute from being downwards slid so that the digging part is tightly wedged and positioned, and a digging height of the digging part is increased.

In an exemplary embodiment, while the machine body is connected with the digging part through vertical lifting, the advance and retreat automatic control system based on the hydraulic sensing conversion includes a digging part locking device and the like provided on the machine body, the digging part locking device includes a gear locker or a pin locker or a tooth row locker or a chain wheel locker or a pressure maintaining locker or a bolt locker or a clamp spring locker or an adjusting fixed cushion locker or a T-type inserting column locker or a tension fixed sleeve locker or a pin rod sleeve locker or a hydraulic pressure balance valve locker and the like.

In an exemplary embodiment, an end part of the walking bracket is provided with a walking hinge lug, the fixed long-arm machine body includes a rocker arm and the like, the rocker arm includes a rocker arm hinge lug and a support arm and the like, the rocker arm further includes a hinge support reciprocated impact box inner cylinder and/or a hinge support reciprocated impact box outer cylinder and the like, while the hinge support reciprocated impact box inner cylinder is installed on the rocker arm, a reciprocated impact box includes a reciprocated impact box connecting outer cylinder and the like, while the hinge support reciprocated impact box outer cylinder is installed on the rocker arm, the reciprocated impact box includes a reciprocated impact box connecting inner cylinder and the like, the rocker arm hinge lug is installed at a rear end of the support arm and hinged with the walking hinge lug, the hinge support reciprocated impact box outer cylinder and/or the hinge support reciprocated impact box inner cylinder is installed at a front end of the support arm, the reciprocated impact box connecting inner cylinder is installed in the reciprocated impact box connecting outer cylinder for stop sleeve connection or the reciprocated impact box connecting inner cylinder is installed in the reciprocated impact box connecting outer cylinder for rotation sleeve connection, one end, towards the reciprocated impact box, of the hinge support reciprocated impact box inner cylinder or the hinge support reciprocated impact box outer cylinder is provided with a connecting reciprocated impact box component, the connecting reciprocated impact box component is connected with the reciprocated impact box or integrated with the reciprocated impact box, the support arm is provided with a reciprocated impact support arm hydraulic pipe cavity, a reciprocated impact hydraulic pipe passes through the reciprocated impact support arm hydraulic pipe cavity and is connected with the digging motor, the digging motor is installed in the hinge support reciprocated impact box inner cylinder and connected with a crank connecting rod or the digging motor is installed outside the hinge support reciprocated impact box inner cylinder and connected with a crank connecting rod, the rocker arm is provided with the telescopic oil cylinder and the swing oil cylinder and the like, one end of the telescopic oil cylinder and one end of the swing oil cylinder are hinged with the rocker arm, and the other end of the telescopic oil cylinder and the swing oil cylinder is hinged with the machine body, a hydraulic pipe is installed in the rocker arm or installed outside the rocker arm, the telescopic oil cylinder is installed in the reciprocated impact box connecting inner cylinder or installed outside the reciprocated impact box connecting inner cylinder, the reciprocated impact box connecting inner cylinder is pushed to be stretched relative to the reciprocated impact box connecting outer cylinder.

In an exemplary embodiment, the hydraulic box includes a hydraulic box body and the like, the hydraulic box body includes a liquid inlet and a liquid outlet and the like, the hydraulic box includes one or more liquid separating plates are installed between the liquid inlet and the liquid outlet, one end of each of one or more liquid separating plates is seal-connected with the hydraulic box body at a liquid outlet end, and the other end of the each of one more liquid separating plates is provided with a separating plate liquid flowing channel or a separating plate through hole, liquid is forced to be flowed in the hydraulic box body within a maximum distance through installation of the liquid separating plate, a cavity at two sides of the each of one or more liquid separating plates is internally provided with a cooling water pipe and/or a cooling water cavity and the like, the cooling water pipe is in U-shaped connection arrangement so as to form a U-shaped cooling water pipe row, a U-shaped bottom of the U-shaped cooling water pipe row is installed towards a bottom plate of the hydraulic box body, or while the hydraulic box body is internally provided with the hydraulic pipe, a U-shaped bottom of the U-shaped cooling water pipe row is upward, a U-shaped port is buttoned at an upper part of the hydraulic pipe so as to disassemble and maintain conveniently, the hydraulic box body is internally provided with a U-shaped cooling water pipe row fixing component, the U-shaped cooling water pipe row fixing component is installed at the bottom of the hydraulic box body and/or installed on the liquid separating plate, the liquid inlet is provided with a liquid return filter and the like, the liquid enters the hydraulic box body from the liquid inlet through the liquid return filter or the liquid directly enters the hydraulic box body and is flowed along the one or more liquid separating plates under blocking of the one or more liquid separating plates and flowed to the liquid outlet through the separating plate liquid flowing channel or the separating plate through hole, the each of the one or more liquid separating plates prevents the liquid from being directly flowed from the liquid inlet to the liquid outlet, the liquid is forced to be circularly flowed in the hydraulic box body, the cooling water pipe and/or the cooling water cavity is used for cooling liquid while the liquid is flowed from one end to the other end, the U-shaped cooling water pipe row increases a cooling area and improves cooling stability performance.

In an exemplary embodiment, the advance and retreat automatic control system based on the hydraulic sensing conversion includes a scraper conveyer and the like provided on a lower part of the machine body, the walking bracket includes a walking bracket bottom plate and the like, the machine body power part includes a machine body power part bottom plate and the like, a part of the walking bracket bottom plate and the machine body power part bottom plate opposite to the scraper conveyer is provided with a coal passing channel, a conveying amount of the dug material is improved, or the walking bracket bottom plate and the machine body power part bottom plate are installed approximate to the scraper conveyer, a height of the machine body is reduced for digging a low material, or the machine body is installed in a convex shape, a length of an narrow convex part of the convex shape is approximate to a length of the digging part box body, the length of the digging part box body is shortened to reduce a weight of the digging part, a wide long part of the convex shape is greater than the narrow convex part of convex shape, a support force and anti-shock gravity of the machine body to the digging part are increased, and a lateral tension force of the digging part to the machine body is relatively reduced, a width of a convex part of the convex shape is approximate to a width of the scraper conveyer, a lower part of the convex part of the convex shape is installed approximate to the scraper conveyer or the coal passing channel is installed between the lower part of the convex part of the convex shape and the scraper conveyer, the material dug by the digging part is conveyed out of a digging area through convex hollow space by the scraper conveyer.

In an exemplary embodiment, the advance and retreat automatic control system based on the hydraulic sensing conversion includes a water spray cooling component and the like provided on the rocker arm or the reciprocated impact box or the machine body, the water spray cooling component includes a water spray cooling pipe and/or a sprayer and the like, the water spray cooling pipe passes through the reciprocated impact support arm hydraulic pipe cavity and is connected with the cooling water pipe or the water spray cooling pipe is connected with the digging part or the water spray cooling pipe is installed on the machine body and the like.

In an exemplary embodiment, the machine body includes a control operation platform and the like, the control operation platform includes a machine body control operation platform and/or a remote control operation platform and the like, while the machine body control operation platform is used, the machine body control operation platform and the hydraulic pump are leftwards and rightwards installed or forwards and backwards installed, or while the remote control operation platform is used, the remote control operation platform is set as an electric drive remote control operation platform or set as a hydraulic drive remote control operation platform, while the control operation platform and the hydraulic pump are leftwards and rightwards installed, a reinforced rib plate and the like is installed between the control operation platform and the hydraulic pump, the reinforced rib plate is capable of reinforcing anti-shock and tensile strength of the machine body, the advance and retreat automatic control system based on the hydraulic sensing conversion includes a hydraulic drive remote control device and the like, the hydraulic drive remote control device includes a closed-type hydraulic drive remote control device or an opened-type hydraulic drive remote control device and the like, while the closed-type hydraulic drive remote control device is used, the closed-type hydraulic drive remote control device includes a closed-type hydraulic pump, a hydraulic pipe, a pressurizing pump, a pilot valve and a closed-type hydraulic drive remote control operation platform and the like, the hydraulic pipe is connected with the pilot valve and the closed-type hydraulic pump and the like, the pressurizing pump and the pilot valve are installed on the closed-type hydraulic drive remote control operation platform, the pilot valve includes a walking pilot valve and a blanking pilot valve and the like, the walking pilot valve controls a walking speed of the machine body, the blanking pilot valve controls a blanking amount of the digging part, or while the opened-type hydraulic drive remote control device is used, the opened-type hydraulic drive remote control device includes an opened-type volume adjustable hydraulic pump, a load-sensitive multi-path control valve, a hydraulic pipe, a pressurizing pump, a pilot valve and an opened-type hydraulic drive remote control operation platform and the like, the hydraulic pipe is connected with the multi-path control valve, the pilot valve and the hydraulic pump and the like, the pressurizing pump and the pilot valve are installed on the opened-type hydraulic drive remote control operation platform, the pilot valve includes a walking pilot valve and a blanking pilot valve and the like, the walking pilot valve controls the walking speed of the machine body, the blanking pilot valve controls the blanking amount of the digging part, the hydraulic drive remote control device remotely operates a digger through the hydraulic drive control, which is simple in structure, safe and reliable, high in efficiency, and strong in adaptability.

The sequence valve and the hydraulic operated directional valve are used in sub-assembly or used by forming a sequence conversion cartridge valve, or the sequence valve, the pressure reducing valve and the hydraulic operated directional valve are used in sub-assembly or used by forming a pressure reducing direction reversing cartridge valve, or the energy accumulator, the sequence valve, the pressure reducing valve and the hydraulic operated directional valve are used in sub-assembly or used by forming an energy accumulation sequence pressure reducing direction reversing cartridge valve.

The machine body further includes a digging part lifting hydraulic cylinder and the like, the digging part lifting hydraulic cylinder includes a digging part single-lifting hydraulic cylinder or a digging part double-lifting hydraulic cylinder and the like, while the digging part double-lifting hydraulic cylinder is used, the digging part includes the digging motor and the like, the digging part double-lifting hydraulic cylinder includes a digging part left-lifting hydraulic cylinder and a digging part right-lifting hydraulic cylinder and the like, the digging part left-lifting hydraulic cylinder and the digging part right-lifting hydraulic cylinder are installed at two sides of the digging motor, the machine body is provided with a suspension digging part left guiding component and a suspension digging part right guiding component and the like, the digging part is provided with a suspension machine body left guiding component and a suspension machine body right guiding component and the like matched with it, the machine body further includes a digging part left-lifting guiding rod and a digging part right-lifting guiding rod and the like, the digging part left-lifting guiding rod passes through and is connected with the suspension digging part left guiding component and the suspension machine body left guiding component, the digging part right-lifting guiding rod passes through and is connected with the suspension digging part right guiding component and the suspension machine body right guiding component, the digging part left-lifting hydraulic cylinder and the digging part right-lifting hydraulic cylinder are installed between the suspension digging part left guiding component and the suspension digging part right guiding component, the digging part left-lifting hydraulic cylinder is installed approximate to the suspension digging part left guiding component, the digging part right-lifting hydraulic cylinder is installed approximate to the suspension digging part right guiding component, one end of the digging part left-lifting hydraulic cylinder is fixed on the machine body or fixed on the digging part, while one end of the digging part left-lifting hydraulic cylinder is fixed on the machine body, the lifting digging part is provided with a left connection lifting oil cylinder lug, while one end of the digging part right-lifting hydraulic cylinder is fixed on the machine body, the lifting digging part is provided with a right connection lifting oil cylinder lug, the digging part left-lifting hydraulic cylinder includes a connection left-lifting oil cylinder pin and the like, the digging part right-lifting hydraulic cylinder includes a connection right-lifting oil cylinder pin and the like, the connection left-lifting oil cylinder pin passes through and is connected with the digging part left-lifting hydraulic cylinder and the left connection lifting oil cylinder lug, the connection right-lifting oil cylinder pin passes through and is connected with the digging part right-lifting hydraulic cylinder and the right connection lifting oil cylinder lug, while the digging part needs to be ascended, the digging part is simultaneously lifted by the digging part left-lifting hydraulic cylinder and the digging part right-lifting hydraulic cylinder, the suspension machine body left guiding component is upwards slid along the digging part left-lifting guiding rod, the suspension machine body right guiding component is upwards slid along the digging part right-lifting guiding rod, the digging part left-lifting guiding rod and the digging part right-lifting guiding rod are capable of fixing a left-right direction of the slid digging part, the digging part left-lifting hydraulic cylinder and the digging part right-lifting hydraulic cylinder support the lifted digging part, as to ensure the stable lifting of the digging part, a digging height of the digging part is increased or a dinting mining depth of the digging part is increased.

The oil cylinder includes a rocker arm telescopic oil cylinder and/or a rocker arm swing oil cylinder and/or a rocker arm lifting oil cylinder, the advance and retreat automatic device based on the hydraulic sensing conversion is installed on the telescopic rocker arm or installed on the machine body or installed on the digging part, the front end of the telescopic rocker arm is provided with the digging head, the advance and retreat automatic device based on the hydraulic sensing conversion controls the rocker arm oil cylinder or controls the walking motor, while the force of the telescopic rocker arm stretched out and pushed against the material is greater than the stretching force of the rocker arm oil cylinder and the overpressure occurs, the advance and retreat automatic device based on the hydraulic sensing conversion is capable of enabling the hydraulic oil to be flowed into the backward retreat cavity of the rocker arm oil cylinder, and enabling the telescopic rocker arm to be backwards retreated, at this moment, the overpressure in the forward advance cavity is released, the hydraulic oil is shifted into the forward advance cavity and the telescopic rocker arm is forwards stretched out, or while the force of the machine body which is forwards advanced and pushed against the material is greater than the force of the walking motor and the overpressure occurs, the advance and retreat automatic device based on the hydraulic sensing conversion controls the walking motor to be backwards retreated, the overpressure is released, and the walking motor is forwards advanced; or according to the hardness of the material which needs to be dug, the normal digging pressure value of the digging motor is determined, the pressure value of the rocker arm oil cylinder is enabled to be matched with the normal digging pressure value of the digging motor, while the digging head is leftwards and rightwards swung and digs the excessive hard material and the pressure value of the digging motor is in the overpressure, the oil cylinder automatic telescopic mechanism based on the hydraulic sensing conversion is capable of enabling the rocker arm swing oil cylinder to be retreated, the digging motor dose not damage the digging component because of the digging motor is not stopped by the overpressure due to digging the excessive hard material, sensing the hardness of the dug material is achieved by the oil cylinder automatic telescopic mechanism based on the hydraulic sensing conversion in forward and backward impact, leftward and rightward sawing, and upward and downward material digging processes of the digging head, the digging part, the rocker arm oil cylinder, the walking motor and the like are protected in advance.

The beneficial effects of some embodiments of the present disclosure are as follows.

1. The pressure of the motor advance and retreat automatic device based on the hydraulic sensing conversion is enabled to be less than the pressure value of the overpressure state of the digging motor, or the pressure of the oil cylinder automatic telescopic device based on the reciprocated impact hydraulic sensing conversion is enabled to be less than the pressure value of the overpressure state of the digging motor, or the pressure of the oil cylinder automatic telescopic device based on the digging hydraulic sensing conversion is enabled to be less than the pressure value of the overpressure state of the digging oil cylinder; while the digging motor encounters with the overlarge resistance, the pressure of the digging motor is instantly increased to exceed the setting pressure value, hydraulic oil enters the hydraulic operated directional valve, the valve rod is pushed so that the walking motor is reversely rotated, the ultrahigh pressure state of the digging motor is released to restore the normal pressure value for the reciprocated impact, and the valve rod of the hydraulic operated directional valve is reset, so the walking motor is forwards rotated for advancing, or while the digging motor encounters with the overlarge resistance, the pressure of the digging motor is instantly increased to exceed the setting pressure value, the hydraulic oil enters the hydraulic operated directional valve through the sequence valve, the valve rod is pushed so that the walking motor is reversely rotated, the ultrahigh pressure state of the digging motor is released to restore the normal pressure value for the reciprocated impact, the walking motor is forwards rotated for advancing, or while the digging motor encounters with the overlarge resistance, the pressure of the digging motor is instantly increased to exceed the setting pressure value, the hydraulic oil enters the hydraulic operated directional valve through the sequence valve and the pressure reducing valve, the valve rod is pushed so that the hydraulic oil enters the retreat cavity of the rocker arm oil cylinder, and the cylinder rod is retreated, the ultrahigh pressure state of the digging motor is released to restore the normal pressure value for the reciprocated impact, or while the digging motor encounters with the overlarge resistance, the pressure of the digging motor is instantly increased to exceed the setting pressure value, the hydraulic oil enters the hydraulic operated directional valve through the energy accumulator, the sequence valve and the pressure reducing valve, the valve rod is pushed so that the hydraulic oil enables the walking motor to be reversely rotated, the ultrahigh state of the digging motor is enabled to be released, the walking motor is enabled to be forwards rotated for advancing.

A, the sequence valve is cooperated with the hydraulic operated directional valve to ensure the precision of retreat and advance restoration of the walking motor, or ensure the precision of retreat and advance restoration of the telescopic oil cylinder.

B, the sequence valve and the pressure reducing valve are cooperated with the hydraulic operated directional valve to ensure the precision of retreat and advance restoration of the motor or the telescopic oil cylinder, and ensure that the speed and distance of retreat and advance restoration are adjustable while the motor is in the overpressure state, or ensure that the speed and distance of retreat and advance restoration are adjustable while the telescopic oil cylinder is in the overpressure state.

C, the energy accumulator, the sequence valve and the pressure reducing valve are cooperated with the hydraulic operated directional valve to ensure the speed and precision of retreat and advance restoration of the rocker arm oil cylinder, and ensure that the speed and distance of retreat and advance restoration of the cylinder rod are adjustable while the rocker arm oil cylinder is in the overpressure state, the energy accumulator, the sequence valve and the hydraulic operated directional valve and the like are cooperated to ensure working stability of the motor, and improve working efficiency of the hydraulic system.

D, through the installation of the advance and retreat automatic device based on the hydraulic sensing conversion, the telescopic oil cylinder is enabled to be retreated in overload or the motor is enabled to be backwards retreated in overload, the telescopic oil cylinder or the motor instantly relieve an ultrahigh pressure jacking force, the hydraulic oil is flowed into the stretching cavity of the telescopic oil cylinder or the hydraulic oil is flowed into a motor advance oil inlet, and advance and retreat automatic continuous work based on hydraulic sensing conversion is achieved.

E, a working condition that the telescopic oil cylinder or the motor is frequently stopped for a long time by the overload so that the serious damage may not be released is changed, and service life of the telescopic oil cylinder or the motor is greatly improved.

F, the hydraulic oil is used as a signal source for performing energy conversion acting so as to achieve automatic sensing, automatic energy conversion, automatic buffering, and automatic restoration work of the digger and the excavator, the original electric automation control of the digger and the excavator is replaced by the advance and retreat automatic control system based on the hydraulic sensing conversion, the advance and retreat automatic control system based on the hydraulic sensing conversion is less in component, small in volume, simple in structure, strong in anti-shock capacity, strong in anti-overload capacity, high in safety factor, low in manufacturing cost, excessively small in maintenance cost and maintenance amount, and long in service life.

2. According to the hardness of the material which needs to be dug, the normal digging pressure value of the digging motor is determined, and the pressure value of the walking motor is adjusted so that it is matched with the normal digging pressure value of the digging motor, while the pressure value of the digging motor needs to be improved when the hard material is impacted, the pressure value of the advance and retreat automatic device system based on hydraulic sensing conversion is improved so that it is matched with the pressure value of the digging motor, while the digging motor digs the excessive hard material, the pressure of the digging motor exceeds the setting pressure value, the motor advance and retreat automatic mechanism based on the hydraulic sensing conversion is capable of enabling the walking motor to be reversely rotated for retreating, the digging motor dose not damage the digging component because of the digging motor is not stopped by the overpressure due to digging the excessive hard material, sensing the hardness of the dug material is achieved by the motor advance and retreat automatic mechanism based on the hydraulic sensing conversion and the digging part is protected in advance; or according to the hardness of the material which needs to be dug, the normal digging pressure value of the digging motor is determined, the pressure value of the rocker arm oil cylinder is enabled to be matched with the normal digging pressure value of the digging motor, while the digging motor digs the excessive hard material, the pressure value of the digging motor is instantly increased to exceed the setting pressure value, the oil cylinder automatic telescopic mechanism based on the hydraulic sensing conversion is capable of enabling the rocker arm oil cylinder to be retreated, the digging motor dose not damage the digging component because of the digging motor is not stopped by the overpressure due to digging the excessive hard material, sensing the hardness of the dug material is achieved by the oil cylinder automatic telescopic mechanism based on the hydraulic sensing conversion and the digging part is protected in advance; or according to the hardness of the material which needs to be dug, the normal digging current value of the digging generator is determined, the pressure value of the walking motor is enabled to be matched with the normal digging current value of the digging generator, while the digging motor digs the excessive hard material, the pressure of the walking motor is instantly increased to exceed the setting pressure value, the advance and retreat automatic device based on the hydraulic sensing conversion is capable of enabling the walking motor to be reversely rotated for retreating, while the digging generator digs the excessive hard material, the current is improved and the digging generator is not stopped by the overload, the walking motor is instantly reversely rotated for retreating, and the digging generator dose not damage the digging component because of the digging generator is not stopped by the overload due to digging the excessive hard material, sensing the hardness of the dug material is achieved by the advance and retreat automatic device based on the hydraulic sensing conversion and the digging part and the walking part are protected in advance, total life and working efficiency of the whole system are improved.

3. The hydraulic box, the hydraulic pump and a pump generator and the like of the advance and retreat automatic control system based on the hydraulic sensing conversion form the machine body power part, the hydraulic pump absorbs liquid and converts the liquid into power source, the advance and retreat automatic device based on the hydraulic sensing conversion controls the rocker arm telescopic oil cylinder or controls the walking motor, while the force of the telescopic rocker arm stretched out and pushed against the material is greater than the forward stretching force of the rocker arm telescopic oil cylinder and the overpressure occurs, the advance and retreat automatic device based on the hydraulic sensing conversion controls the hydraulic oil to be flowed into the backward retreat cavity of the rocker arm telescopic oil cylinder, the telescopic rocker arm is enabled to be backwards retreated, at this moment, the overpressure in the forward advance cavity is released, the advance and retreat automatic device based on the hydraulic sensing conversion is capable of enabling the hydraulic oil to be shifted into the forward advance cavity and the telescopic rocker arm is forwards stretched out, or while the force of the machine body which is forwards advanced and pushed against the material is greater than the force of the motor and the overpressure occurs, the advance and retreat automatic device based on the hydraulic sensing conversion controls the hydraulic oil to be flowed into the motor backward walking cavity, the motor is enabled to be backwards retreated, at this moment, the overpressure in the forward walking cavity is released so that the hydraulic oil is shifted into the forward walking cavity, the motor is forwards walked, the reciprocated impact motor drives the crank connecting rod and the like, the crank connecting rod drives the digging head to be reciprocated and impacted, or the reciprocated impact oil cylinder drives the digging head to be reciprocated and impacted. The beneficial effects of the digger of the system are as follows.

A. a bottleneck problem that the cutting and blanking part of the existing digger for mining adopts the motor power and enables the cutting roller to be rotated for milling and blanking through the gear transmission, while the hard coal and the gangue above f4 is encountered, the torque of a rotation cutting motor is increased for a overloaded operation so as to frequently cause the motor to be burned and the suspend production is caused, and the production efficiency is restricted is effectively solved.

B. a bottleneck problem that the existing reciprocated impact digger uses the motor to drive the crank connecting rod which drives the impact head to be reciprocated and impacted, because the motor does not have the buffering performance, the damage to the motor is also caused frequently, and the production efficiency is restricted is solved.

C. because the motor is used for driving the rotation roller or the digging head for blanking, a number of electric control original components is reduced, a volume of the electric control box is reduced, a control system of the equipment is simplified, and reliability of the control system is improved.

D. a problem that the digging head driven by the hydraulic motor is frequently pushed against the material wall so as to cause the transient pressure overload, and the digging motor and the walking motor are caused to be stopped operating is solved.

E. through the installation of the advance and retreat automatic device based on the hydraulic sensing conversion, while the digging head is pushed against the material wall so that the digging head may not be reciprocated and impacted, the telescopic rocker arm is retreated, the ultrahigh pressure jacking force is instantly released by the reciprocated impact oil cylinder, the hydraulic oil is flowed into the reciprocated impact oil cylinder and the digging head is driven to be continuously reciprocated and impacted.

F. the hydraulic system is used for achieving advance and retreat automatic adjustment continuous digging and excavating of the reciprocated impact digger and the reciprocated impact excavator, and achieving hydraulic automation digging and excavating of the reciprocated impact digger and the reciprocated impact excavator.

G. a working condition that while the high-hardness coal wall and rock wall and the like are impacted by the reciprocated impact digger and the reciprocated impact excavator, the impact head is frequently stopped by jacking for a long time and the serious damage may not be buffered is changed, service life of reciprocated impact tooth is greatly improved, the occurrence of a condition that the pump motor is stopped for a long time by the overload is avoided, and service life of the power system is greatly improved.

4. While the pressurizer is used, the pressurizer is installed on the pump output pipeline or installed on the motor oil inlet pipeline or installed on the hydraulic cylinder oil inlet pipeline or installed on the advance and retreat automatic device based on the hydraulic sensing conversion, or while the energy accumulator is used, the energy accumulator is installed on the pump output pipeline or installed on the motor oil inlet pipeline or installed on the hydraulic cylinder oil inlet pipeline or installed on the advance and retreat automatic device based on the hydraulic sensing conversion, the pressurizer or the energy accumulator is used for avoiding defects that load shedding is easy while the digging motor, the excavating motor, the walking motor, and the oil cylinder and the like encounters with the larger resistance, so the operation of the hydraulic control system is more stable and reliable.

5. The machine body fixed digging part structure is buttoned on the digging part suspension machine body fixing structure, the machine body lifting digging part structure is cooperated with the digging part suspension machine body lifting structure, the straight sliding rail is buttoned with the straight sliding chute so that the digging part is connected with the machine body, the small-upper large-lower wedge-shaped sliding chute is buttoned with the small-upper large-lower wedge-shaped sliding rail, under the effect of gravity of the digging part, the small-upper large-lower wedge-shaped sliding chute is closely buttoned on the small-upper large-lower wedge-shaped sliding rail, the digging part is firmly suspended on the machine body without the auxiliary component so as to increase shock strength, or the machine body lifting digging part structure is installed on the end face of the machine body towards the coal wall to be mined or installed on the front part of the machine body, the corresponding digging part suspension machine body lifting structure is installed on the end face of the digging part towards the machine body or installed on the front part of the machine body, or while the slide connection of the machine body and the digging part is used, the machine body is slidably buttoned with the digging part and the digging part is lifted by the external force, while the T-type pin column is used, the lower part of the T-type pin column is inserted in the tension digging part suspension machine body lifting structure pin column hole, and the upper part of the T-type pin column is buttoned with the digging part suspension machine body lifting structure, or while the straight pin fixed sleeve column is used, the lower part of the sliding rail inserting hole column is inserted in the tension digging part suspension machine body lifting structure pin column hole, and the upper part of the sliding rail inserting hole column is buttoned with the tension digging part fixed sleeve so that the exterior of the tension digging part fixed sleeve is buttoned with the digging part suspension machine body lifting structure, the tension digging part suspension machine body lifting structure pin column hole supports and fixes the sliding rail inserting hole column, the sliding rail inserting hole column fixes the tension digging fixed sleeve, the digging part suspension machine body lifting structure tightly holds the sliding rail inserting hole column through the tension digging part fixed sleeve, the fixing strength of the digging part and the machine body is increased, or the machine body is provided with the lifting digging part hydraulic cylinder, the digging part suspension machine body lifting structure is buttoned with the machine body lifting digging part structure so that the digging part is suspended on the machine body, while the digging part needs to be ascended, the lifting digging part hydraulic cylinder is capable of enabling the digging part suspension machine body lifting structure to be upwards slid to the required height for positioning along the machine body lifting digging part structure, or while the small-upper large-lower wedge-shaped sliding rail and the small-upper large-lower wedge-shaped sliding chute are used for lifting the digging part, the small-upper large-lower wedge-shaped sliding chute is firstly ascended, according to the position which needs to be ascended, the adjusting fixed cushion is installed in the small-upper large-lower wedge-shaped sliding chute, the adjusting fixed cushion is disposed between the small-upper large-lower wedge-shaped sliding rail and the small-upper large-lower wedge-shaped sliding chute so as to prevent the small-upper large-lower wedge-shaped sliding chute from being downwards slid so that the digging part is tightly wedged and positioned, and the digging height of the digging part is increased.

6. The digging part locking device is beneficial to enable the digging part to be firmly locked with the machine body, the digging part is avoided from being upwards and downwards or leftwards and rightwards moved relative to the machine body while the material is impacted, stability and reliability of the digging part and the machine body in a working process are improved, and an occurrence rate of a digging fault is reduced.

7. The rocker arm hinge lug is installed at the rear end of the support arm and hinged with the walking hinge lug, the support reciprocated impact box outer cylinder is installed at the front end of the support arm, the hinge support reciprocated impact box inner cylinder is installed in the hinge support reciprocated impact box outer cylinder and rotated relative to the hinge support reciprocated impact box outer cylinder, the reciprocated impact hydraulic pipe passes through the reciprocated impact support arm hydraulic pipe cavity of the rocker arm and is connected with the digging motor, the digging motor is installed in the hinge support reciprocated impact box inner cylinder and connected with the crank connecting rod or the digging motor is installed outside the hinge support reciprocated impact box inner cylinder and connected with the crank connecting rod, two ends of the lifting oil cylinder are respectively hinged with the rocker arm and the machine body, the rocker arm lifting hydraulic valve controls the lifting oil cylinder, the lifting oil cylinder drives the rocker arm to be lifted so as to increase the digging height, the digging motor is directly connected with a crank shaft of the reciprocated impact power box, the hydraulic motor is used for driving the digging part to be reciprocated and impacted for blanking so as to avoid installation that after a rotation speed, about 1500 revolutions, of the motor is reduced through the gear box, the rotation speed is transmitted to the cutting roller or transmitted to the crank connecting rod, and avoid a complicated structure that the rocker arm is used as a gear transmission box and the power is transmitted to the rotation roller or the reciprocated impact box, in the premise without changing a length of the rocker arm, width and height of the rocker arm are greatly reduced, space where the coal enters the scraper conveyer from a side part and a lower part of the rocker arm is increased, the efficiency of conveying the coal is improved, a harsh disadvantage structure that it is necessarily ensured that a power shaft of the rotation roller is parallel to a power shaft of a gear of the rocker arm gear box because the rocker arm transmits the power through the gear is avoided, a size of a connecting part of the rocker arm and the rotation roller is reduced, the rocker arm is simple in manufacturing and low in cost, a requirement that a power shaft of the digging motor is perpendicular to the height of the rocker arm is reduced, and service life of a coal mining machine is improved.

8. One or more liquid separating plates and the like are installed between the liquid inlet and the liquid outlet of the hydraulic box body, one end of the liquid separating plate is seal-connected with the hydraulic box body at the liquid outlet end, and the other end of the liquid separating plate is provided with the separating plate liquid flowing channel or the separating plate through hole, the liquid is forced to be flowed in the hydraulic box body within the maximum distance through installation of the liquid separating plate, the cavity at two sides of the liquid separating plate is internally provided with the cooling water pipe and/or the cooling water cavity, the cooling water pipe is in U-shaped connection arrangement so as to form the U-shaped cooling water pipe row, the U-shaped bottom of the U-shaped cooling water pipe row is installed towards the bottom plate of the hydraulic box body, or while the hydraulic box body is internally provided with the hydraulic pipe, the U-shaped bottom of the U-shaped cooling water pipe row is upwards buttoned at a upper part of the hydraulic pipe so as to disassemble and maintain conveniently, the hydraulic box body is internally provided with the U-shaped cooling water pipe row fixing component, the U-shaped cooling water pipe row fixing component is installed at the bottom of the hydraulic box body and/or installed on the liquid separating plate, the liquid enters the hydraulic box body from the liquid inlet through the liquid return filter and is flowed along the liquid separating plate under blocking of the liquid separating plate and flowed to the liquid outlet through the separating plate liquid flowing channel or the separating plate through hole, the liquid separating plate prevents the liquid from being directly flowed from the liquid inlet to the liquid outlet, the liquid is forced to be circularly flowed in the hydraulic box body, the cooling water pipe and/or the cooling water cavity is used for cooling the liquid while the liquid is flowed from one end of the cooling water pipe and/or the cooling water cavity to the other end of the cooling water pipe and/or the cooling water cavity, the U-shaped cooling water pipe row increases the cooling area, namely a volume of the hydraulic box is reduced and the service life of the hydraulic system is improved.

9. The lower part of the machine body is provided with the scraper conveyer, the part of the walking bracket bottom plate and the machine body power part bottom plate opposite to the scraper conveyer is upwards protruded to form the coal passing channel, the conveying amount of the dug material is improved, or the walking bracket bottom plate and the machine body power part bottom plate are installed approximate to the scraper conveyer, the height of the machine body is reduced for digging the low material, or the machine body is installed in a convex shape, a length of an narrow convex part of the convex shape is approximate to a length of the digging part box body, the length of the digging part box body is shortened to reduce the weight of the digging part, a wide long part of the convex shape is greater than the narrow convex part of the convex shape, the support force and the anti-shock gravity of the machine body to the digging part are increased, and the lateral tension force of the digging part to the machine body is relatively reduced, a width of a convex part of the convex shape is approximate to a width of the scraper conveyer, the lower part of the convex part of the convex shape is installed approximate to the scraper conveyer or the coal passing channel is installed between the lower part of convex part of the convex shape and the scraper conveyer, the material dug by the digging part is conveyed out of the digging area through the convex hollow space by the scraper conveyer, the wide long part of the convex shape is greater than the narrow convex part of the convex shape, the weight of the machine body is increased, the length of the digging part is reduced, walking stability of the machine body is improved, a weight of an impact part is reduced, length and weight of the whole machine are reduced, and stability and working efficiency of the whole machine are improved.

10. The rocker arm and/or the reciprocated impact box is provided with a water spray cooling component and the like, the water spray cooling pipe passes through the reciprocated impact support arm hydraulic pipe cavity and is connected with the cooling water pipe, the reciprocated impact support arm hydraulic pipe cavity effectively protects the hydraulic pipe and the cooling water pipe, and a space utilization ratio is improved, so the whole machine is simple and compact in structure, less in easily damaged part, small in maintenance amount, reliable in performance, and high in efficiency.

11. While the control operation platform and the hydraulic pump are leftwards and rightwards installed, the reinforced rib plate is installed between the control operation platform and the hydraulic pump, the reinforced rib plate is capable of reinforcing the anti-shock and tensile strength of the machine body, and improving the operation stability and the service life of the machine body, while the closed-type hydraulic drive remote control device is used, the hydraulic pipe is connected with the closed-type pilot valve and the closed-type hydraulic pump, the closed-type pilot valve is installed on the closed-type hydraulic drive remote control operation platform, the closed-type walking pilot valve controls the walking speed of the machine body, the closed-type blanking pilot valve controls the blanking amount of the digging part, or while the opened-type hydraulic drive remote control device is used, the opened-type hydraulic pipe is connected with the load-sensitive control valve, the opened-type pilot valve and the opened-type hydraulic pump, the opened-type pilot valve is installed on the opened-type hydraulic drive remote control operation platform, the opened-type walking pilot valve controls the walking speed of the machine body, the opened-type blanking pilot valve controls the blanking amount of the digging part, the hydraulic drive remote control device remotely operates the digger through the hydraulic drive control, so an operator is far away from a digging fracture surface, personal safety of the operator is ensured, especially for digging a low ore bed, a digging person does not need to enter a digging face for operating, the labor intensity of the digging person is released, the digging efficiency is improved, the hydraulic drive remote control is simple and reliable in structure, high in efficiency, strong in adaptability, and safe in anti-explosion.

12. Through the installation of the sequence conversion cartridge valve, the pressure reducing direction reversing cartridge valve, and the energy accumulation sequence pressure reducing direction reversing cartridge valve, each component of the advance and retreat automatic device based on the hydraulic sensing conversion is integrated, and it is beneficial to install each component of the advance and retreat automatic device based on the hydraulic sensing conversion in small space, so the advance and retreat automatic device based on the hydraulic sensing conversion is clean and tidy in appearance, compact in structure, simple and rapid in installation, stable in performance, safe and reliable.

13. While the digging part double-lifting hydraulic cylinder is used, the digging part left-lifting hydraulic cylinder and the digging part right-lifting hydraulic cylinder are installed at two sides of the digging motor, the digging part left-lifting guiding rod passes through and is connected with the suspension digging part left guiding component and the suspension machine body left guiding component, the digging part right-lifting guiding rod passes through and is connected with the suspension digging part right guiding component and the suspension machine body right guiding component, the digging part left-lifting hydraulic cylinder and the digging part right-lifting hydraulic cylinder are installed between the suspension digging part left guiding component and the suspension digging part right guiding component, the digging part left-lifting hydraulic cylinder is installed approximate to the suspension digging part left guiding component, the digging part right-lifting hydraulic cylinder is installed approximate to the suspension digging part right guiding component, one end of the digging part left-lifting hydraulic cylinder is fixed on the machine body or fixed on the digging part, while one end of the digging part left-lifting hydraulic cylinder is fixed on the machine body, the lifting digging part is provided with the left connection lifting oil cylinder lug, while one end of the digging part right-lifting hydraulic cylinder is fixed on the machine body, the lifting digging part is provided with the right connection lifting oil cylinder lug, the left-lifting oil cylinder pin passes through and is connected with the digging part left-lifting hydraulic cylinder and the left connection lifting oil cylinder lug, the right-lifting oil cylinder pin passes through and is connected with the digging part right-lifting hydraulic cylinder and the right connection lifting oil cylinder lug, while the digging part needs to be ascended, the digging part is simultaneously lifted by the digging part left-lifting hydraulic cylinder and the digging part right-lifting hydraulic cylinder, the suspension machine body left guiding component and the suspension machine body right guiding component are upwards slid respectively along the digging part left-lifting guiding rod and the digging part right-lifting guiding rod, the digging part left-lifting guiding rod and the digging part right-lifting guiding rod are capable of fixing the left-right direction of the slid digging part, the digging part left-lifting hydraulic cylinder and the digging part right-lifting hydraulic cylinder support the lifted digging part, as to ensure the stable lifting of the digging part, the digging height of the digging part is increased or the dinting mining depth of the digging part is increased, the machine lifting digging part structure is cooperated with the digging part suspension machine body lifting structure, as to eliminate the complicated easily-shaken rocker arm which is installed from a front side edge of the machine body, slantwise supported by the oil cylinder and hinged with the machine body, and avoid shaking of the slantwise supported rocker arm from buffer-absorbing energy of the digging head which reciprocated-impacts the material, it is beneficial to enable the reciprocated impact digging part to be firmly suspended on the machine body, so an easily rotated and shaken hinge structure is eliminated from the machine body and the digging part, and a connecting surface of the machine body and the digging part is enabled to be plane connection, the plane connection enables the machine body to be large in straightening surface for the digging part, the shaking of the digging part caused by a counter-acting force of the reciprocated impact of the digging part is effectively eliminated, a straightening degree of the machine body to the digging part is increased, a utilization ratio of digging kinetic energy is improved, the kinetic energy is saved, damage to components caused by the shaking is reduced, a maintenance amount is reduced, and digging efficiency is improved.

14. The advance and retreat automatic device based on the hydraulic sensing conversion is installed on the telescopic rocker arm or installed on the machine body or installed on the digging part, the advance and retreat automatic device based on the hydraulic sensing conversion controls the rocker arm oil cylinder or controls the walking motor, while the force of the telescopic rocker arm stretched out and pushed against the material is greater than the stretching force of the rocker arm oil cylinder and the overpressure occurs, the advance and retreat automatic device based on the hydraulic sensing conversion is capable of enabling the hydraulic oil to be flowed into the backward retreat cavity of the rocker arm oil cylinder, and enabling the telescopic rocker arm to be backwards retreated, at this moment, the overpressure in the forward advance cavity is released, the hydraulic oil is shifted into the forward advance cavity and the telescopic rocker arm is forwards stretched out, or while the force of the machine body which is forwards advanced and pushed against the material is greater than the force of the walking motor and the overpressure occurs, the advance and retreat automatic device based on the hydraulic sensing conversion controls the walking motor to be backwards retreated, the overpressure is released, and the walking motor is forwards advanced, or according to the hardness of the material which needs to be dug, the normal digging pressure value of the digging motor is determined, the pressure value of the rocker arm oil cylinder is enabled to be matched with the normal digging pressure value of the digging motor, while the digging head is leftwards and rightwards swung and digs the excessive hard material and the pressure value of the digging motor is in overpressure, the oil cylinder automatic telescopic mechanism based on the hydraulic sensing conversion is capable of enabling the rocker arm swing oil cylinder to be retreated, the digging motor dose not damage the digging component because of the digging motor is not stopped by the overpressure due to digging the excessive hard material, sensing the hardness of the dug material is achieved by the oil cylinder automatic telescopic mechanism based on the hydraulic sensing conversion in forward and backward impact, leftward and rightward sawing, and upward and downward material digging processes of the digging head, the digging part, the rocker arm oil cylinder, the walking motor and the like are protected in advance, overload automatic advance and retreat protection is performed on the rocker arm lifting oil cylinder, the rocker arm swing oil cylinder and the rocker arm telescopic oil cylinder by the oil cylinder automatic telescopic mechanism based on the hydraulic sensing conversion, waste of time, manpower and energy caused by restarting due to overload stoppage is avoided, serious damage to each component of the digger and the excavator due to the counter-acting force of continuous work in an overpressure state is avoided, the maintenance amount is reduced, the labor intensity of the operator is released, and the working efficiency and the service life of the whole machine are greatly improved. Sensing the hardness of the dug material is achieved by the advance and retreat automatic device based on the hydraulic sensing conversion and the digging part is protected in advance, the system does not need manual operation, and is capable of digging automatically, the present disclosure is capable of enabling the pressure to be ascended without depressurizing while the digging motor encounters with the excessive hard material and enabling the machine body to be continuously advanced to drive the digging part for digging after retreated to the setting distance, so the digger has the advantages of achieving automatic digging without an electric control automation box, higher reliability, higher efficiency, no any one electric control automatic easily-damaged component, higher safety, and automatic coal mining of the hydraulic control, any motors and electric devices are not burned while the overload occurs, a spark hidden danger is not existent and explosion is absolutely prevented, the walking and digging parts are enabled to achieve soft start, and the digger is anti-shock, anti-torque, anti-moisture and waterproof, anti-rust, anti-misoperation, high in safety and long in service life.

### BRIEF DESCRIPTION OF THE DRAWINGS

FIG. 1 is a hydraulic schematic diagram of an advance and retreat automatic control system based on hydraulic sensing conversion in Embodiment 1;

FIG. 2 is a hydraulic schematic diagram of an advance and retreat automatic control system based on hydraulic sensing conversion in Embodiment 2;

FIG. 3 is a hydraulic schematic diagram of an advance and retreat automatic control system based on hydraulic sensing conversion in Embodiment 3;

FIG. 4 is a hydraulic schematic diagram of an advance and retreat automatic control system based on hydraulic sensing conversion in Embodiment 4;

FIG. 5 is a hydraulic schematic diagram of an advance and retreat automatic control system based on hydraulic sensing conversion in Embodiment 5;

FIG. 6 is a structure schematic diagram of an advance and retreat automatic control system based on hydraulic sensing conversion including a fixed long-arm machine body in Embodiment 6;

FIG. 7 is the structure schematic diagram of the advance and retreat automatic control system based on the hydraulic sensing conversion including the fixed long-arm machine body in Embodiment 6;

FIG. 8 is a structure schematic diagram of an advance and retreat automatic control system based on hydraulic sensing conversion including a telescopic arm machine body in Embodiment 7;

FIG. 9 is a hydraulic schematic diagram of an advance and retreat automatic control system based on hydraulic sensing conversion in Embodiment 8;

FIG. 10 is a hydraulic schematic diagram of an advance and retreat automatic control system based on hydraulic sensing conversion in Embodiment 9;

FIG. 11 is a structure schematic diagram of a walking hinge lug installed at an end part of a walking bracket in Embodiment 10;

FIG. 12 is the structure schematic diagram of the walking hinge lug installed at the end part of the walking bracket in Embodiment 10;

FIG. 13 is a structure schematic diagram of a reciprocated impact support arm hydraulic pipe cavity installed in Embodiment 10;

FIG. 14 is a structure schematic diagram of connection of a rocker arm and a reciprocated impact box in Embodiment 10;

FIG. 15 is a structure schematic diagram of a crank connecting rod driven by a digging motor in Embodiment 10;

FIG. 16 is a structure schematic diagram of a hydraulic box body in Embodiment 11;

FIG. 17 is a structure schematic diagram of a water spray cooling component installed in Embodiment 12;

FIG. 18 is a hydraulic schematic diagram of an advance and retreat automatic control system based on hydraulic sensing conversion in Embodiment 13;

FIG. 19 is a hydraulic schematic diagram of an advance and retreat automatic control system based on hydraulic sensing conversion in Embodiment 14;

FIG. 20 is a schematic diagram of an advance and retreat automatic control system based on hydraulic sensing conversion in Embodiment 15;

FIG. 21 is a hydraulic schematic diagram of the advance and retreat automatic control system based on the hydraulic sensing conversion in Embodiment 15;

FIG. 22 is a schematic diagram of an advance and retreat automatic control system based on hydraulic sensing conversion in Embodiment 16;

FIG. 23 is the schematic diagram of the advance and retreat automatic control system based on the hydraulic sensing conversion in Embodiment 16;

FIG. 24 is a schematic diagram of an advance and retreat automatic control system based on hydraulic sensing conversion in Embodiment 17;

FIG. 25 is a schematic diagram of an advance and retreat automatic control system based on hydraulic sensing conversion in Embodiment 18;

FIG. 26 is a schematic diagram of an advance and retreat automatic control system based on hydraulic sensing conversion in Embodiment 19;

FIG. 27 is the schematic diagram of the advance and retreat automatic control system based on the hydraulic sensing conversion in Embodiment 19;

FIG. 28 is a schematic diagram of an advance and retreat automatic control system based on hydraulic sensing conversion in Embodiment 20;

FIG. 29 is the schematic diagram of the advance and retreat automatic control system based on the hydraulic sensing conversion in Embodiment 20;

FIG. 30 is a schematic diagram of the narrow convex part of the convex shape in the machine body and the wide long part of the convex shape in Embodiment 21;

FIG. 31 is a schematic diagram of an oil cylinder lifting suspension guiding system in Embodiment 22;

FIG. 32 is a schematic diagram of an oil cylinder lifting suspension system in Embodiment 22; and

FIG. 33 is a schematic diagram of a rocker arm telescopic oil cylinder and rocker arm swing oil cylinder system in Embodiment 23.

In the drawings: 1, walking motor; 2, hydraulic operated directional valve; 3, advance and retreat automatic device based on hydraulic sensing conversion; 4, multi-path control valve; 5, hydraulic pump; 6, digging motor; 7, sequence valve; 8, pressure reducing valve; 9, rocker arm oil cylinder; 10, energy accumulator; 11, digging head; 12, reciprocated impact box; 13, digging part; 14, motor; 15, walking bracket; 16, machine body; 17, hydraulic box; 18, fixed long-arm machine body; 19, machine body power part; 20, pump motor; 21, control operation platform; 22, reciprocated impact oil cylinder; 23, rocker arm telescopic oil cylinder; 24, telescopic rocker arm; 25, telescopic arm machine body; 26, pressurizer; 27, walking hinge lug; 28, hinge support reciprocated impact box inner cylinder; 29, support arm; 30, reciprocated impact support arm hydraulic pipe cavity; 31, rocker arm; 32, rocker arm hinge lug; 33, lifting oil cylinder; 34, connection reciprocated impact box component; 35, reciprocated impact box connection outer cylinder; 36, crank connecting rod; 37, hydraulic box body bottom plate; 38, upper part buttoned on hydraulic pipe; 39, U-shaped cooling water pipe row; 40, hydraulic box body; 41, liquid outlet; 42, liquid separating plate; 43, cooling water pipe; 44, fixed U-shaped cooling water pipe row component; 45, separating plate liquid flowing channel; 46, liquid inlet; 47, liquid return filter; 48, coal passing space; 49, walking bracket bottom plate; 50, coal passing channel; 51, scraper conveyer; 52, water spray cooling pipe; 53, digging generator; 54, digging part suspension machine body fixing structure; 55, digging part suspension machine body lifting structure; 56, straight sliding rail; 57, straight sliding chute; 58, small-upper large-lower wedge-shaped sliding chute; 59, small-upper large-lower wedge-shaped sliding rail; 60, motor gear; 61, fixed digging part structure; 62, machine body lifting digging part structure; 63, impact part and machine body locker; 64, tension digging part suspension machine body lifting structure pin column; 65, tension digging part suspension machine body lifting structure pin column hole; 66, energy accumulation assistance reciprocated impact part; 67, closed-type hydraulic pump; 68, closed-type hydraulic drive remote control operation platform; 69, closed-type pilot valve; 70, closed-type hydraulic pipe; 71, opened-type hydraulic drive remote control operation platform; 72, opened-type hydraulic drive remote control device; 73, opened-type hydraulic pump; 74, load-sensitive control valve; 75, opened-type hydraulic pipe; 76, opened-type pilot valve; 77, machine body oil cylinder connecting plate; 78, machine body power part bottom plate; 79, narrow convex part of the convex shape; 80, wide long part of the convex shape; 81, digging part box body; 82, digging part lifting hydraulic cylinder; 83, digging part left-lifting hydraulic cylinder; 84, digging part right-lifting hydraulic cylinder; 85, suspension digging part left guiding component; 86, suspension digging part right guiding component; 87, suspension machine body left guiding component; 88, suspension machine body right guiding component; 89, digging part left-lifting guiding rod; 90, digging part right-lifting guiding rod; 91, connection left-lifting oil cylinder pin; 92, connection right-lifting oil cylinder pin; 93 left connection lifting oil cylinder lug; 94, right connection lifting oil cylinder lug; 95, rocker arm swing oil cylinder; and 96, directly connected digging part machine body.

### DETAILED DESCRIPTION OF THE EMBODIMENTS

### Embodiment 1

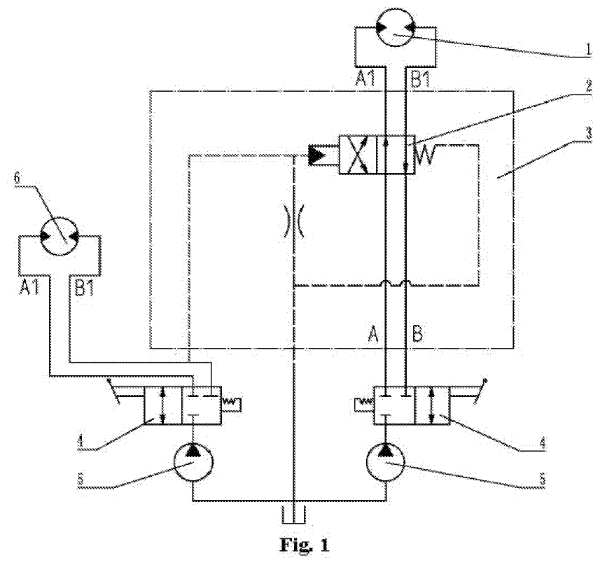

As shown in FIG. 1, Embodiment 1 is an advance and retreat automatic control system based on hydraulic sensing conversion, the advance and retreat automatic control system based on the hydraulic sensing conversion includes an advance and retreat automatic device based on hydraulic sensing conversion 3, the advance and retreat automatic control system based on the hydraulic sensing conversion further includes a motor 14 and the like, the advance and retreat automatic device based on the hydraulic sensing conversion 3 includes a hydraulic operated directional valve 2, the motor 14 includes a digging motor 6 and a walking motor 1 and the like, the advance and retreat automatic device based on the hydraulic sensing conversion 3 is cooperated with the digging motor 6 and the walking motor 1 so as to form a motor 14 advance and retreat automatic mechanism based on hydraulic sensing conversion, a pressure value of the advance and retreat automatic device based on the hydraulic sensing conversion is less than a pressure value of an overpressure state of the digging motor 6, while the digging motor 6 encounters with an excessive large resistance, a pressure value of the digging motor 6 is instantly increased to exceed a setting pressure value, hydraulic oil enters the hydraulic operated directional valve 2, a valve rod is pushed so that the walking motor 1 is reversely rotated, an ultrahigh pressure state of the digging motor 6 is released to restore a normal pressure value for the reciprocated impact, and the valve rod of the hydraulic operated directional valve 2 is reset, so the walking motor 1 is forwards rotated for advancing, a hydraulic pump 5 is used as a power source which provides power for the system through a multi-path control valve 4, continuous and stable work of the advance and retreat automatic control system based on the hydraulic sensing conversion is ensured, the advance and retreat automatic continuous work is achieved, and working efficiency is improved.

The motor 14 is the digging motor 6 or the walking motor 1.

The advance and retreat automatic control system based on the hydraulic sensing conversion is an oil cylinder and/or a generator.

### Embodiment 2

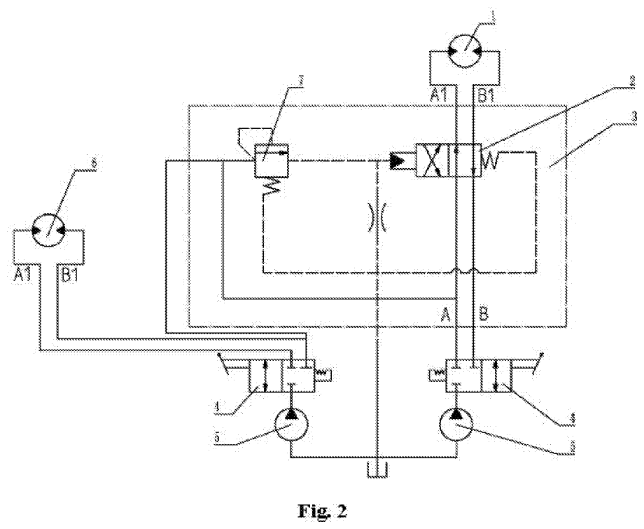

As shown in FIG. 2, Embodiment 2 is an advance and retreat automatic control system based on hydraulic sensing conversion, the advance and retreat automatic control system based on the hydraulic sensing conversion includes an advance and retreat automatic device based on hydraulic sensing conversion 3, the advance and retreat automatic control system based on the hydraulic sensing conversion further includes a motor 14 and the like, the advance and retreat automatic device based on the hydraulic sensing conversion 3 includes a sequence valve 7 and a hydraulic operated directional valve 2 and the like, the motor 14 includes a digging motor 6 and a walking motor 1 and the like, the advance and retreat automatic device based on the hydraulic sensing conversion 3 is cooperated with the digging motor 6 and the walking motor 1 so as to form a motor 14 advance and retreat automatic mechanism based on hydraulic sensing conversion, a pressure value of the advance and retreat automatic device based on the hydraulic sensing conversion is less than a pressure value of an overpressure state of the digging motor 6, while the digging motor 6 encounters with an overlarge resistance, a pressure value of the digging motor 6 is instantly increased to exceed a setting pressure value, hydraulic oil enters the hydraulic operated directional valve 2 through the sequence valve 7, a valve rod is pushed so that the walking motor 1 is reversely rotated, an ultrahigh pressure state of the digging motor 6 is released to restore a normal pressure value for the reciprocated impact, the walking motor 1 is forwards rotated for advancing, and the sequence valve 7 is cooperated with the hydraulic operated directional valve 2 to ensure precision of retreat and advance restoration of the walking motor 1.

The sequence valve 7 and the hydraulic operated directional valve 2 are used in sub-assembly or used by forming a sequence conversion cartridge valve.

In an exemplary embodiment, the motor 14 is the digging motor 6 or the walking motor 1.

In an exemplary embodiment, the advance and retreat automatic control system based on the hydraulic sensing conversion is an oil cylinder and/or a generator.

### Embodiment 3

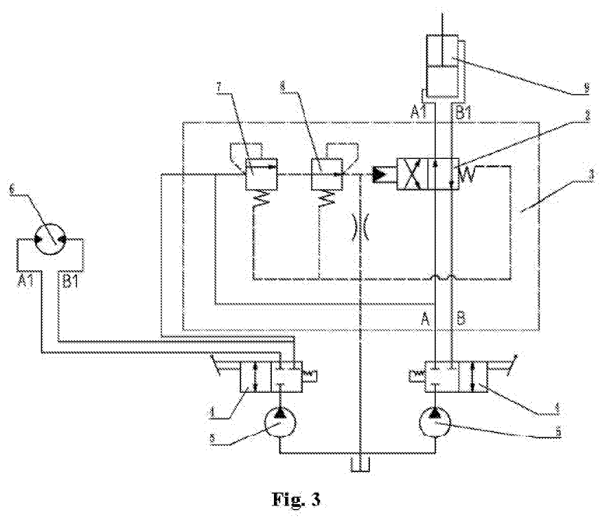

As shown in FIG. 3, Embodiment 3 is an advance and retreat automatic control system based on hydraulic sensing conversion, the advance and retreat automatic control system based on the hydraulic sensing conversion includes an advance and retreat automatic device based on hydraulic sensing conversion 3, the advance and retreat automatic control system based on the hydraulic sensing conversion further includes a motor 14, an oil cylinder and the like, or the advance and retreat automatic device based on the hydraulic sensing conversion 3 includes a sequence valve 7, a pressure reducing valve 8 and a hydraulic operated directional valve 2 and the like, the motor 14 includes a digging motor 6 and a walking motor 1 and the like, the oil cylinder includes a rocker arm oil cylinder 9 and/or a digging oil cylinder, the advance and retreat automatic device based on the hydraulic sensing conversion 3 is cooperated with the digging motor 6 and the rocker arm oil cylinder 9 so as to form an oil cylinder advance and retreat automatic mechanism based on reciprocated impact hydraulic sensing conversion, a pressure value of a motor advance and retreat automatic device based on hydraulic sensing conversion is less than a pressure value of an overpressure state of the digging motor 6, or a value pressure of an oil cylinder advance and retreat automatic device based on reciprocated impact hydraulic sensing conversion is less than the pressure value of the overpressure state of the digging motor 6, or a pressure value of an oil cylinder automatic telescopic device based on digging hydraulic sensing conversion is less than a pressure value of an overpressure state of the digging oil cylinder, while the digging motor 6 encounters with an overlarge resistance, a pressure value of the digging motor 6 is instantly increased to exceed a setting pressure value, hydraulic oil enters the hydraulic operated directional valve 2 through the sequence valve 7 and the pressure reducing valve 8 and the like, a valve rod is pushed so that the hydraulic oil enters a retreat cavity of the rocker arm oil cylinder 9, and a cylinder rod is retreated, an ultrahigh pressure state of the digging motor 6 is released to restore a normal pressure value for the reciprocated impact, the sequence valve 7 and the pressure reducing valve 8 are cooperated with the hydraulic operated directional valve 2 so as to ensure precision of retreat and advance restoration of the rocker arm oil cylinder 9, and ensure that retreat speed and distance of the cylinder rod are adjustable while the rocker arm oil cylinder 9 encounters with an overpressure state.

The sequence valve 7, the pressure reducing valve 8 and the hydraulic operated directional valve 2 are used in sub-assembly or used by forming a pressure reducing direction reversing cartridge valve.

In an exemplary embodiment, the motor 14 is the digging motor 6 or the walking motor 1.

In an exemplary embodiment, the advance and retreat automatic control system based on the hydraulic sensing conversion is a generator.

Or the advance and retreat automatic device based on the hydraulic sensing conversion 3 is cooperated with the digging oil cylinder and the rocker arm oil cylinder 9 so as to form an oil cylinder automatic telescopic mechanism based on digging hydraulic sensing conversion, a pressure of an oil cylinder advance and retreat automatic telescopic device based on digging hydraulic sensing conversion is less than the pressure value of the overpressure state of the digging oil cylinder.

### Embodiment 4

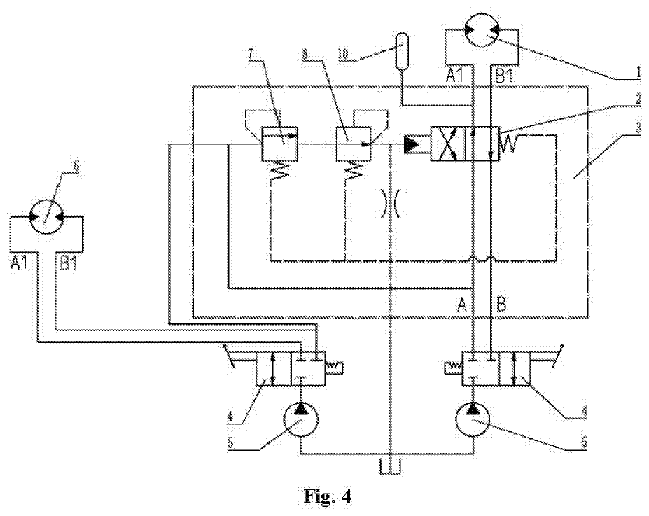

As shown in FIG. 4, Embodiment 4 is an advance and retreat automatic control system based on hydraulic sensing conversion, the advance and retreat automatic control system based on the hydraulic sensing conversion includes an advance and retreat automatic device based on hydraulic sensing conversion 3, the advance and retreat automatic control system based on the hydraulic sensing conversion further includes a motor 14, an oil cylinder and the like, the advance and retreat automatic device based on the hydraulic sensing conversion 3 includes an energy accumulator 10, a sequence valve 7, a pressure reducing valve 8 and a hydraulic operated directional valve 2 and the like, the motor 14 includes a digging motor 6 and a walking motor 1 and the like, the oil cylinder includes a rocker arm oil cylinder 9 and/or a digging oil cylinder, the advance and retreat automatic device based on the hydraulic sensing conversion 3 is cooperated with the digging motor 6 and the walking motor 1 so as to form a motor 14 advance and retreat automatic mechanism based on hydraulic sensing conversion, or the advance and retreat automatic device based on the hydraulic sensing conversion 3 is cooperated with the digging motor 6 and the rocker arm oil cylinder 9 so as to form an oil cylinder automatic telescopic mechanism based on reciprocated impact hydraulic sensing conversion, a pressure value of a motor advance and retreat automatic device based on hydraulic sensing conversion is less than a pressure value of an overpressure state of the digging motor 6, or a pressure value of an oil cylinder automatic telescopic device based on reciprocated impact hydraulic sensing conversion is less than the pressure value of the overpressure state of the digging motor 6, while the digging motor 6 encounters with an overlarge resistance, a pressure value of the digging motor 6 is instantly increased to exceed a setting pressure value, hydraulic oil enters the hydraulic operated directional valve 2 through the energy accumulator 10, the sequence valve 7 and the pressure reducing valve 8 and the like, a valve rod is pushed so that the hydraulic oil enables the walking motor 1 to be reversely rotated, an ultrahigh state of the digging motor 6 is released, the walking motor 1 is forwards rotated for advancing, and the energy accumulator 10, the sequence valve 7 and the pressure reducing valve 8 are cooperated with the hydraulic operated directional valve 2 so as to ensure speed and precision of retreat and advance restoration of the rocker arm oil cylinder 9, and ensure that retreat speed and distance of a cylinder rod are adjustable while the rocker arm oil cylinder 9 encounters with an overpressure state.

The energy accumulator 10, the sequence valve 7, the pressure reducing valve 8 and the hydraulic operated directional valve 2 are used in sub-assembly or used by forming an energy accumulation sequence pressure reducing direction reversing cartridge valve.

The advance and retreat automatic control system based on the hydraulic sensing conversion is also a generator.

In an exemplary embodiment, the motor 14 includes the digging motor 16 or the walking motor 1.

### Embodiment 5

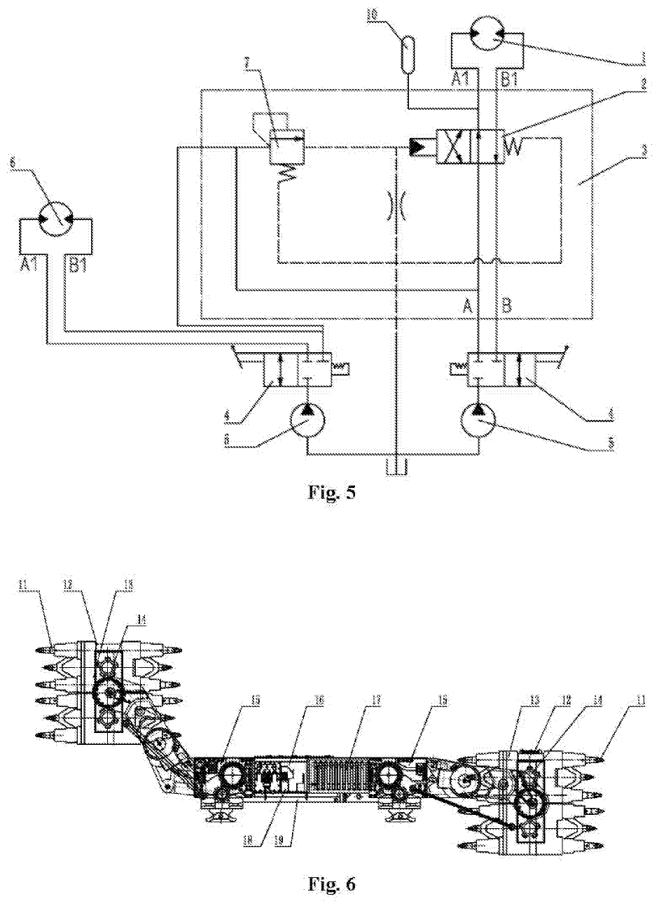

As shown in FIG. 5, Embodiment 5 is an advance and retreat automatic control system based on hydraulic sensing conversion, the advance and retreat automatic control system based on the hydraulic sensing conversion includes an advance and retreat automatic device based on hydraulic sensing conversion 3, the advance and retreat automatic control system based on the hydraulic sensing conversion further includes a motor 14, an oil cylinder and the like, the advance and retreat automatic device based on the hydraulic sensing conversion 3 includes an energy accumulator 10, a sequence valve 7 and a hydraulic operated directional valve 2 and the like, the motor 14 includes a digging motor 6 and a walking motor 1 and the like, the advance and retreat automatic device based on the hydraulic sensing conversion 3 is cooperated with the digging motor 6 and the walking motor 1 so as to form a motor 14 advance and retreat automatic mechanism based on hydraulic sensing conversion, a pressure value of a motor advance and retreat automatic device based on hydraulic sensing conversion is less than a pressure value of an overpressure state of the digging motor 6, while the digging motor 6 encounters with an overlarge resistance, a pressure value of the digging motor 6 is instantly increased to exceed a setting pressure value, hydraulic oil enters the hydraulic operated directional valve 2 through the sequence valve 7, a valve rod is pushed so that the walking motor 1 is reversely rotated for retreating, an ultrahigh state of the digging motor 6 is released to restore a normal pressure value for the reciprocated impact, the walking motor 1 is forwards rotated for advancing, and the sequence valve 7 is cooperated with the hydraulic operated directional valve 2 so as to ensure precision of retreat and advance restoration of the walking motor 1.

In an exemplary embodiment, the motor 14 is the digging motor 6 or the walking motor 1.

The advance and retreat automatic control system based on the hydraulic sensing conversion may also be a generator.

According to Embodiment 1, Embodiment 2, Embodiment 3, Embodiment 4 and Embodiment 5, the disclosure provides an advance and retreat automatic control method based on hydraulic sensing conversion correspondingly. The advance and retreat automatic control method based on hydraulic sensing conversion includes: one, the advance and retreat automatic device based on hydraulic sensing conversion 3 is installed, the advance and retreat automatic device based on the hydraulic sensing conversion 3 is enabled to be formed by the hydraulic operated directional valve 2, or the advance and retreat automatic device based on the hydraulic sensing conversion 3 is enabled to be formed by the sequence valve 7 and a hydraulic operated directional valve 2, or the advance and retreat automatic device based on the hydraulic sensing conversion 3 is enabled to be formed by a sequence valve 7, a pressure reducing valve 8 and a hydraulic operated directional valve 2, or the advance and retreat automatic device based on the hydraulic sensing conversion 3 is enabled to be formed by an energy accumulator 10, a sequence valve 7 and a hydraulic operated directional valve 2, or the advance and retreat automatic device based on the hydraulic sensing conversion 3 is enabled to be formed by an energy accumulator 10, a sequence valve 7, a pressure reducing valve 8 and a hydraulic operated directional valve 2.

Two, the advance and retreat automatic device based on the hydraulic sensing conversion 3 is enabled to be cooperated with the digging motor 6 and the walking motor 1 so as to form the motor 14 advance and retreat automatic mechanism based on the hydraulic sensing conversion, or the advance and retreat automatic device based on the hydraulic sensing conversion 3 is enabled to be cooperated with the digging motor 6 and the rocker arm oil cylinder 9 so as to form an oil cylinder automatic telescopic mechanism based on reciprocated impact hydraulic sensing conversion, or the advance and retreat automatic device based on the hydraulic sensing conversion 3 is enabled to be cooperated with a digging oil cylinder and the rocker arm oil cylinder 9 so as to form an oil cylinder automatic telescopic mechanism based on digging hydraulic sensing conversion, the pressure of the motor advance and retreat automatic device based on the hydraulic sensing conversion is enabled to be less than the pressure value of the overpressure state of the digging motor 6, or a pressure value of an oil cylinder automatic telescopic device based on reciprocated impact hydraulic sensing conversion is enabled to be less than the pressure value of the overpressure state of the digging motor 6, or a pressure value of an oil cylinder automatic telescopic device based on digging hydraulic sensing conversion is enabled to be less than a pressure value of an overpressure state of the digging oil cylinder.

Three, while the digging motor 6 encounters with the overlarge resistance, the pressure of the digging motor 6 is instantly increased to exceed the setting pressure value, the hydraulic oil enters the hydraulic operated directional valve 2, the valve rod is pushed so that the walking motor 1 is reversely rotated, the ultrahigh pressure state of the digging motor 6 is released to restore the normal pressure value for the reciprocated impact, and the valve rod of the hydraulic operated directional valve 2 is reset, so the walking motor 1 is forwards rotated for advancing; or while the digging motor 6 encounters with the overlarge resistance, the pressure of the digging motor 6 is instantly increased to exceed the setting pressure value, the hydraulic oil enters the hydraulic operated directional valve 2 through the sequence valve 7, the valve rod is pushed so that the walking motor 1 is reversely rotated, the ultrahigh pressure state of the digging motor 6 is released to restore the normal pressure value for the reciprocated impact, the walking motor 1 is forwards rotated for advancing, and the sequence valve 7 is cooperated with the hydraulic operated directional valve 2 to ensure precision of retreat and advance restoration of the walking motor 1, or while the digging motor 6 encounters with the overlarge resistance, the pressure of the digging motor 6 is instantly increased to exceed the setting pressure value, the hydraulic oil enters the hydraulic operated directional valve 2 through the sequence valve 7 and the pressure reducing valve 8, the valve rod is pushed so that the hydraulic oil enters a retreat cavity of the rocker arm oil cylinder 9, and a cylinder rod is retreated, the ultrahigh pressure state of the digging motor 6 is released to restore the normal pressure value for the reciprocated impact, the sequence valve 7 and the pressure reducing valve 8 are cooperated with the hydraulic operated directional valve 2 so as to ensure precision of retreat and advance restoration of the rocker arm oil cylinder 9, and ensure that retreat speed and distance of the cylinder rod are adjustable while the rocker arm oil cylinder 9 encounters with an overpressure state, or while the digging motor 6 encounters with the overlarge resistance, the pressure of the digging motor 6 is instantly increased to exceed the setting pressure value, the hydraulic oil enters the hydraulic operated directional valve 2 through the energy accumulator 10, the sequence valve 7 and the pressure reducing valve 8, the valve rod is pushed so that the hydraulic oil enables the walking motor 1 to be reversely rotated, the ultrahigh state of the digging motor 6 is enabled to be released, the walking motor 1 is enabled to be forwards rotated for advancing, and the energy accumulator 10, the sequence valve 7 and the pressure reducing valve 8 are enabled to be cooperated with the hydraulic operated directional valve 2 so as to ensure speed and precision of retreat and advance restoration of the rocker arm oil cylinder 9, and ensure that the retreat speed and distance of the cylinder rod are adjustable while the rocker arm oil cylinder 9 encounters with the overpressure state.

### Embodiment 6

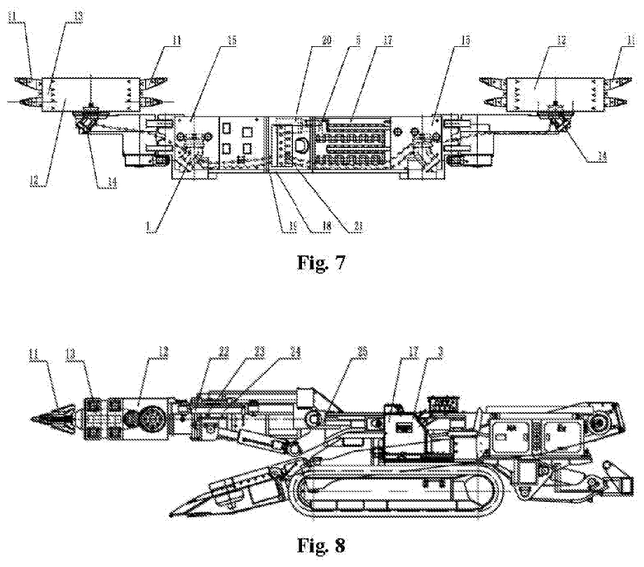

As shown in FIG. 6 and FIG. 7, Embodiment 6 is an advance and retreat automatic control system based on hydraulic sensing conversion, the advance and retreat automatic control system based on the hydraulic sensing conversion includes a machine body 16 and a digging part 13 and the like, the advance and retreat automatic control system based on the hydraulic sensing conversion includes a hydraulic box 17, a hydraulic pump 5 and a pump motor 20 and the like provided on the machine body 16, the hydraulic box 17, the hydraulic pump 5 and the pump motor 20 and the like form a machine body power part 19, two ends of the machine body power part 19 are provided with the digging part 13 and the like, the hydraulic pump 5 absorbs liquid which is converted into a power source, the digging part 13 is provided with the digging motor 6, the machine body 16 includes a walking bracket 15 and the like, the walking bracket 15 is provided with a walking motor 1 or a walking generator and the like, the machine body 16 includes a fixed long-arm machine body 18 and the like, while a force of the machine body 16 which is forwards advanced and pushed against a material is greater than a force of the walking motor 1 and an overpressure occurs, an advance and retreat automatic device based on hydraulic sensing conversion 3 controls the walking motor 1 to be backwards retreated, the overpressure is released, hydraulic oil is shifted into a forward walking cavity, and the walking motor 1 is forwards walked, the digging part 13 includes a reciprocated impact box 12 and a digging head 11 and the like, the digging head 11 is installed at two ends of the reciprocated impact box 12, the reciprocated impact box 12 is provided with a crank connecting rod 36, the digging motor 6 drives the crank connecting rod 36, the crank connecting rod 36 drives the digging head 11 to be reciprocated and impacted, while the digging head 11 is pushed against on a material wall so that the digging head 11 can not be reciprocated and impacted, the advance and retreat automatic device based on the hydraulic sensing conversion 3 enables the walking motor 1 to be backwards retreated.

In some embodiments, one end of the machine body power part 19 is provided with the reciprocated impact box 12, or the digging head 11 is installed at one end of the reciprocated impact box 12.

The machine body 16 includes a control operation platform 21 and the like, the control operation platform 21 and the hydraulic pump 5 are leftwards and rightwards installed or forwards and backwards installed, while the control operation platform 21 and the hydraulic pump 5 are leftwards and rightwards installed, a reinforced rib plate is installed between the control operation platform 21 and the hydraulic pump 5, the reinforced rib plate is capable of reinforcing anti-shock and anti-tension strength of the machine body 16.

Other is the same as Embodiment 1.

### Embodiment 7

As shown in FIG. 8, Embodiment 7 is an advance and retreat automatic control system based on hydraulic sensing conversion, the advance and retreat automatic control system based on the hydraulic sensing conversion includes a machine body 16 and a digging part 13 and the like, the advance and retreat automatic control system based on the hydraulic sensing conversion includes a hydraulic box 17, a hydraulic pump 5 and a pump motor 20 and the like, the hydraulic box 17 provided on the machine body 16, the hydraulic pump 5 and the pump motor 20 form a machine body power part 19 and the like, one end of the machine body power part 19 is provided with a reciprocated impact box 12, the hydraulic pump 5 absorbs liquid which is converted into a power source, the reciprocated impact box 12 is provided with a reciprocated impact oil cylinder 22, the machine body 16 includes a walking bracket 15 and the like, the walking bracket 15 is provided with a walking motor 1 or a walking generator, the machine body 16 includes a telescopic arm machine body 25, the telescopic arm machine body 25 includes a telescopic rocker arm 24, the telescopic rocker arm 24 includes a rocker arm oil cylinder 9, the rocker arm oil cylinder 9 includes a rocker arm telescopic oil cylinder 23 and/or a rocker arm swing oil cylinder 95, an advance and retreat automatic device based on hydraulic sensing conversion 3 is installed on the telescopic rocker arm 24 or installed on the machine body 16 or installed on the digging part 13, a front end of the telescopic rocker arm 24 is provided with a digging head 11, the advance and retreat automatic device based on the hydraulic sensing conversion 3 controls the rocker arm oil cylinder 9, while a force of the telescopic rocker arm 24 stretched out and pushed against a material is greater than a stretching force of the rocker arm oil cylinder 9 and an overpressure occurs, the advance and retreat automatic device based on the hydraulic sensing conversion 3 is capable of enabling hydraulic oil to be flowed into a backward retreat cavity of the rocker arm oil cylinder 9, and enabling the telescopic rocker arm 24 to be backwards retreated, at this moment, the overpressure in a forward advance cavity is released, the hydraulic oil is shifted into the forward advance cavity and the telescopic rocker arm 24 is forwards stretched out, the digging part 13 includes the reciprocated impact box 12 and the digging head 11, the digging head 11 is installed at one end of the reciprocated impact box 12, the reciprocated impact box 12 is provided with the reciprocated impact oil cylinder 22, the reciprocated impact oil cylinder 22 drives the digging head 11 to be reciprocated and impacted, while the digging head 11 is pushed against a material wall so that the digging head 11 can not be reciprocated and impacted, the advance and retreat automatic device based on the hydraulic sensing conversion 3 is capable of enabling the telescopic rocker arm 24 to be retreated.

Other is the same as Embodiment 1.

### Embodiment 8

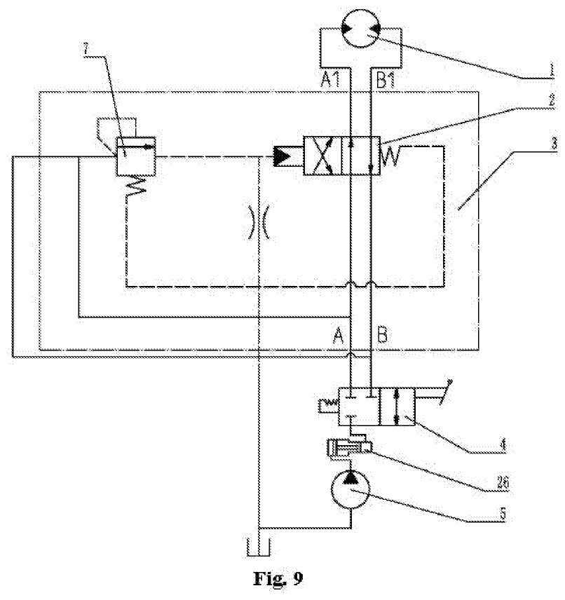

As shown in FIG. 9, Embodiment 8 is an advance and retreat automatic control system based on hydraulic sensing conversion, an advance and retreat automatic device based on hydraulic sensing conversion 3 includes a pressurizer 26 and the like, while the pressurizer 26 is used, the pressurizer 26 is installed on a pump output pipeline.

The pressurizer 26 may also be installed on a motor 14 oil inlet pipeline or installed on a hydraulic cylinder oil inlet pipeline or installed on the advance and retreat automatic device based on the hydraulic sensing conversion 3 and the like.

Other is the same as Embodiment 1.

### Embodiment 9

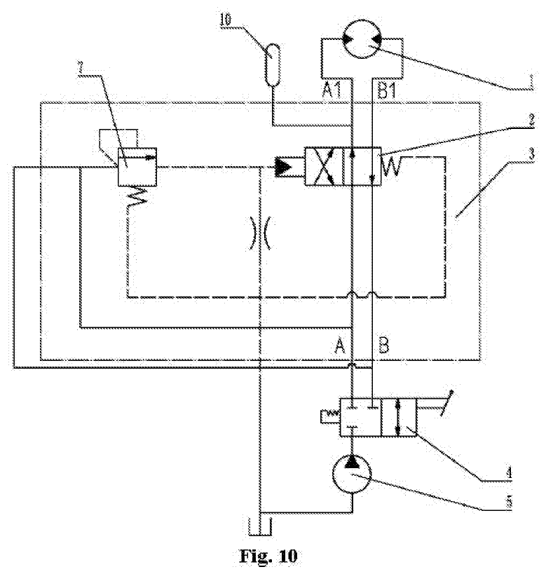

As shown in FIG. 10, Embodiment 9 is an advance and retreat automatic control system based on hydraulic sensing conversion, an advance and retreat automatic device based on hydraulic sensing conversion 3 includes an energy accumulator 10 and the like, while the energy accumulator 10 is used, the energy accumulator 10 is installed on a motor 14 oil inlet pipeline.

The energy accumulator 10 may also be installed on a pump output pipeline or installed on a hydraulic cylinder oil inlet pipeline or installed on the advance and retreat automatic device based on the hydraulic sensing conversion 3 and the like.

Other is the same as Embodiment 1.

### Embodiment 10

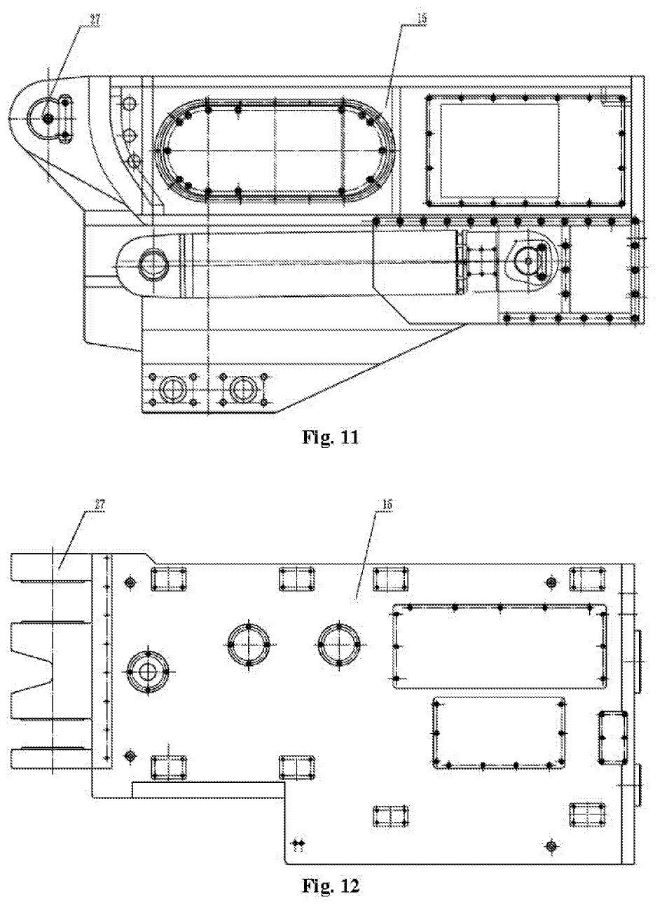

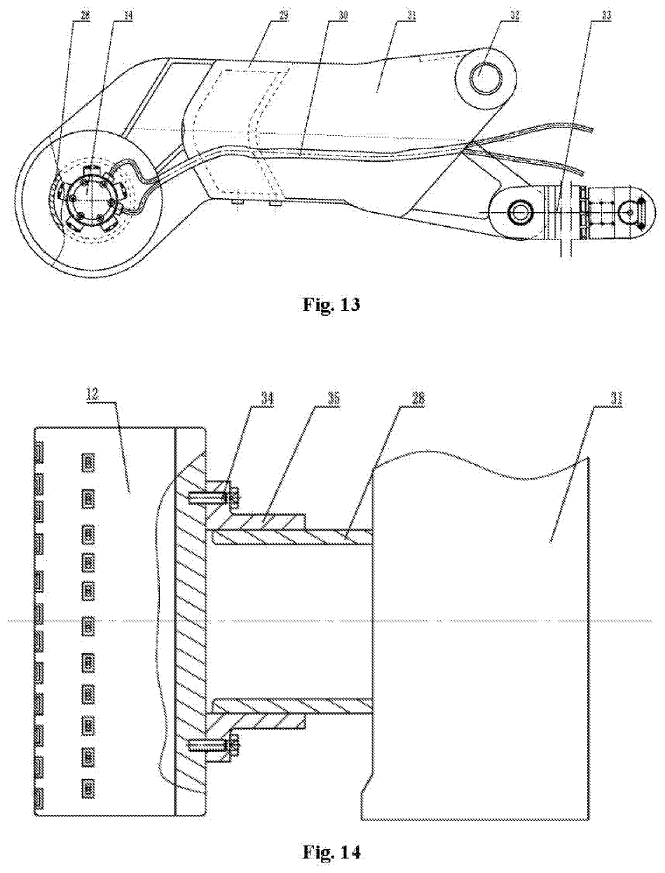

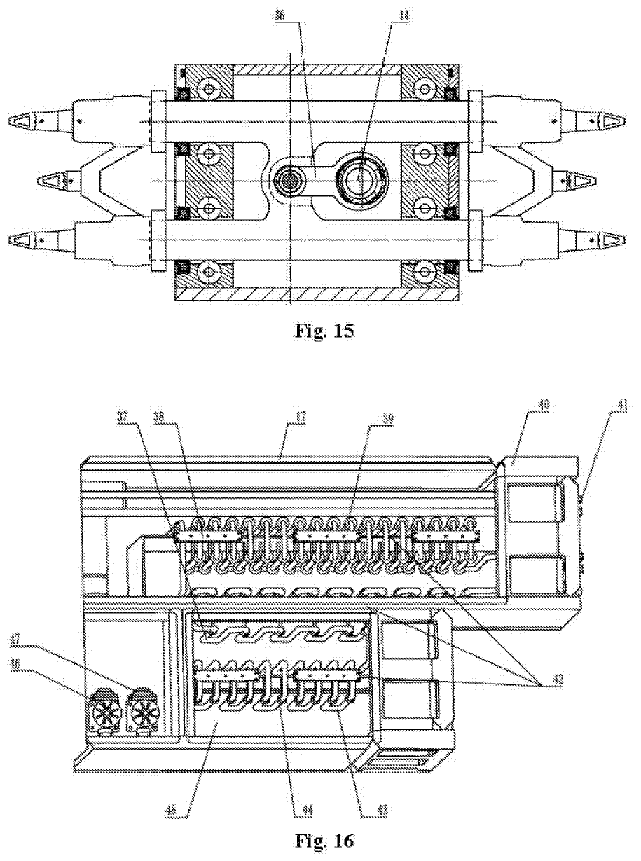

As shown in FIG. 11 to FIG. 15, Embodiment 10 is an advance and retreat automatic control system based on hydraulic sensing conversion, an end part of a walking bracket 15 is provided with a walking hinge lug 27 and the like, a fixed long-arm machine body 18 includes a rocker arm 31 and the like, the rocker arm 31 includes a rocker arm hinge lug 32 and a support arm 29 and the like, the rocker arm 31 further includes a hinge support reciprocated impact box inner cylinder 28 and the like, while the hinge support reciprocated impact box inner cylinder 28 is installed on the rocker arm 31, a reciprocated impact box 12 includes a reciprocated impact box connecting outer cylinder 35 and the like, the rocker arm hinge lug 32 is installed at a rear end of the support arm 29 and hinged with the walking hinge lug 27, the hinge support reciprocated impact box inner cylinder 28 is installed at a front end of the support arm 29, the reciprocated impact box 12 connecting inner cylinder is installed in the reciprocated impact box connecting outer cylinder 35 for stop sleeve connection, one end, towards the reciprocated impact box 12, of the hinge support reciprocated impact box inner cylinder 28 is provided with a connecting reciprocated impact box component 34, the connecting reciprocated impact box component 34 is connected with the reciprocated impact box 12 or integrated with the reciprocated impact box 12, the support arm 29 is provided with a reciprocated impact support arm hydraulic pipe cavity 30, a reciprocated impact hydraulic pipe passes through the reciprocated impact support arm hydraulic pipe cavity 30 and is connected with a digging motor 6, the digging motor 6 is installed in the hinge support reciprocated impact box inner cylinder 28 and connected with a crank connecting rod 36 or the digging motor 6 is installed outside the hinge support reciprocated impact box inner cylinder 28 and connected with the crank connecting rod 36, the rocker arm 31 is provided with a lifting oil cylinder 33, one end of the lifting oil cylinder 33 is hinged with the rocker arm 31, and the other end of the lifting oil cylinder 33 is hinged with a machine body 16, a hydraulic pipe is installed in the rocker arm 31 or installed outside the rocker arm 31.

Or the rocker arm 31 may include a hinge support reciprocated impact box 12 outer cylinder and the like, while the hinge support reciprocated impact box 12 outer cylinder is installed on the rocker arm 31, the reciprocated impact box 12 includes a reciprocated impact box 12 connecting inner cylinder and the like, the rocker arm hinge lug 32 is installed at the rear end of the support arm 29 and hinged with the walking hinge lug 27, the hinge support reciprocated impact box 12 outer cylinder is installed at the front end of the support arm 29, the reciprocated impact box 12 connecting inner cylinder is installed in the reciprocated impact box connecting outer cylinder 35 for rotation and sleeve-connection, one end, towards the reciprocated impact box 12, of the hinge support reciprocated impact box 12 outer cylinder is provided with the connecting reciprocated impact box component 34.

Other is the same as Embodiment 1.

### Embodiment 11

As shown in FIG. 16, Embodiment 11 is an advance and retreat automatic control system based on hydraulic sensing conversion, a hydraulic box 17 includes a hydraulic box body 40 and the like, the hydraulic box body 40 includes a liquid inlet 41 and a liquid outlet 46 and the like, one or more liquid separating plates 42 are installed between the liquid inlet 41 and the liquid outlet 46, one end of the liquid separating plate 42 is seal-connected with the hydraulic box body 40 at a liquid outlet 41 end, and the other end is provided with a separating plate liquid flowing channel 45 or a separating plate through hole and the like, liquid is forced to be flowed in the hydraulic box body 40 within a maximum distance through installation of the liquid separating plate 42, a cavity at two sides of the liquid separating plate 42 is internally provided with a cooling water pipe 43, the cooling water pipe 43 is in U-shaped continuous arrangement so as to form a U-shaped cooling water pipe row 39 and the like, a U-shaped bottom of the U-shaped cooling water pipe row 39 is installed towards a bottom plate 37 of the hydraulic box body, or while the hydraulic box body 40 is internally provided with a hydraulic pipe, the U-shaped bottom of the U-shaped cooling water pipe row 39 is upwards buttoned at an upper part 38 of the hydraulic pipe so as to disassemble and maintain conveniently, the hydraulic box body 40 is internally provided with a U-shaped cooling water pipe row fixing component 44, the U-shaped cooling water pipe row fixing component 44 is installed at the bottom of the hydraulic box body 40 and/or installed on the liquid separating plate 42 and the like, the liquid inlet 46 is provided with a liquid return filter 47, the liquid enters the hydraulic box body 40 from the liquid inlet 46 through the liquid return filter 47 or the liquid directly enters the hydraulic box body 40 and is flowed along the liquid separating plate 42 under blocking of the liquid separating plate 42 and flowed to the liquid outlet 41 through the separating plate liquid flowing channel 45 or the separating plate through hole, the liquid separating plate 42 prevents the liquid from being directly flowed from the liquid inlet 46 to the liquid outlet 41, the liquid is forced to be circularly flowed in the hydraulic box body 40, the cooling water pipe 43 and/or the cooling water cavity is used for cooling liquid while the liquid is flowed from one end to the other end, the U-shaped cooling water pipe row 39 increases a cooling area and improves cooling stability performance.

In an exemplary embodiment, the cavity at two sides of the liquid separating plate 42 is internally provided with a cooling water cavity.

Other is the same as Embodiment 1.

### Embodiment 12

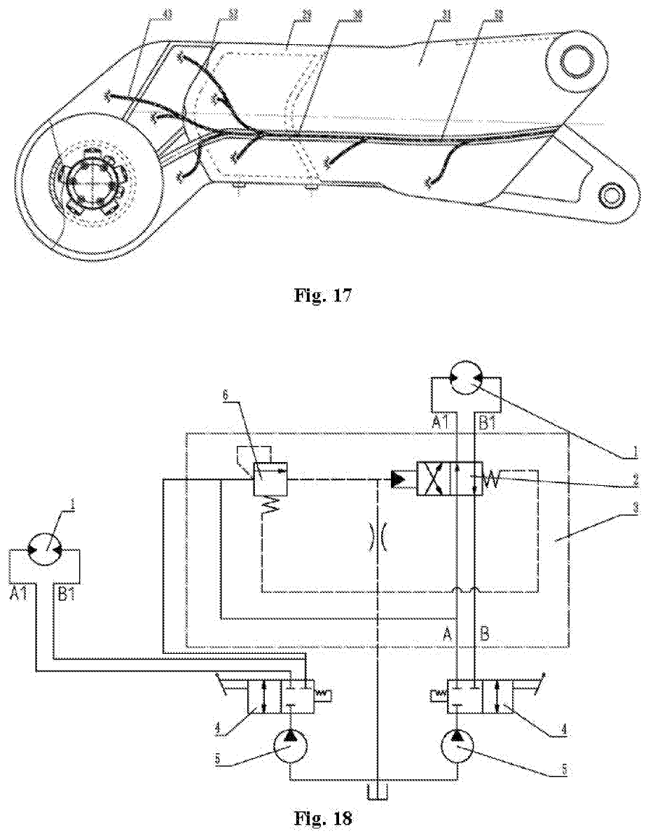

As shown in FIG. 17, Embodiment 12 is an advance and retreat automatic control system based on hydraulic sensing conversion, a difference from Embodiment 5 is as follows: a rocker arm 31 and/or a reciprocated impact box 12 is provided with a water spray cooling component and the like, the water spray cooling component includes a water spray cooling pipe 52 and/or a sprayer and the like, the water spray cooling pipe 52 passes through a reciprocated impact support arm hydraulic pipe cavity 30 and is connected with a cooling water pipe 43.

Other is the same as Embodiment 1.

### Embodiment 13

As shown in FIG. 18, Embodiment 13 is an advance and retreat automatic control system based on hydraulic sensing conversion, according to hardness of a material which needs to be dug, a normal digging pressure value of a digging motor 6 is determined, and a pressure value of a walking motor 1 is adjusted so that it is matched with the normal digging pressure value of the digging motor 6, a pressure value of an advance and retreat automatic device 3 system based on hydraulic sensing conversion is set, a maximum pressure value of the digging motor 6 is higher than a maximum pressure value of the walking motor 1, for example, the pressure value of the walking motor 1 is set as 28 MPa, and the pressure value of the digging motor 6 is set as 30 MPa, normal digging is performed in a state that the pressure value of the digging motor 6 does not exceed the pressure value of the walking motor 1, while the digging motor 6 digs an excessive hard material, the pressure value of the digging motor 6 exceeds the maximum pressure value of the walking motor 1, namely the pressure value of the digging motor 6 is between 28 MPa and 30 MPa, a motor 14 advance and retreat automatic mechanism based on hydraulic sensing conversion is capable of enabling the walking motor 1 to be reversely rotated for retreating, while the digging motor 6 digs the excessive hard material, a pressure is improved to exceed the maximum pressure value of the walking motor 1 and the digging motor 6 is not stopped by overpressure, the walking motor is instantly reversely rotated for retreating, the digging motor 6 dose not damage because of the digging motor 6 is not stopped by the overpressure due to digging the excessive hard material, sensing the hardness of the dug material is achieved by the motor 14 advance and retreat automatic mechanism based on the hydraulic sensing conversion and a digging part 13 is protected in advance.

The system does not need manual operation, and is capable of digging automatically, the present disclosure is capable of enabling the pressure to be ascended without depressurizing while the digging motor 6 encounters with the excessive hard material and enabling the machine body 16 to be continuously advanced to drive the digging part 13 for digging after retreated to a setting distance, so the digger has the advantages of achieving automatic digging without an electric control automation box, higher reliability, higher efficiency, no any one electric control automatic easily-damaged component, higher safety, and automatic coal mining of hydraulic control, any motors and electric devices are not burned while the overload occurs, a spark hidden danger is not existent and explosion is absolutely prevented, the walking and digging parts 13 are enabled to achieve soft start, and the digger is anti-shock, anti-torque, anti-moisture and waterproof, anti-rust, anti-misoperation, high in safety and long in service life.

The structure further corresponds to a method: according to the hardness of the material which needs to be dug, the normal digging pressure value of the digging motor 6 is determined, the pressure value of the walking motor 1 is enabled to be matched with the normal digging pressure value of the digging motor 6, the pressure value of the advance and retreat automatic device 3 system based on the hydraulic sensing conversion is set, the maximum pressure value of the digging motor 6 is enabled to be higher than the maximum pressure value of the walking motor 1, and the normal digging is enabled to be performed in the state that the pressure value of the digging motor 6 does not exceed the pressure value of the walking motor 1, while the digging motor 6 digs the excessive hard material, the pressure value of the digging motor 6 exceeds the maximum pressure value of the walking motor 1, the motor 14 advance and retreat automatic mechanism based on the hydraulic sensing conversion is capable of enabling the walking motor 1 to be reversely rotated for retreating, while the digging motor 6 digs the excessive hard material, the pressure is improved to exceed the maximum pressure value of the walking motor 1 and the digging motor 6 is not stopped by the overpressure, the walking motor 1 is instantly reversely rotated for retreating, the digging motor 16 does not damage because of the digging motor 16 is not stopped by the overpressure due to digging the excessive hard material, sensing the hardness of the dug material is achieved by the motor 14 advance and retreat automatic mechanism based on the hydraulic sensing conversion and the digging part 13 is protected in advance.

Other is the same as Embodiment 1.

### Embodiment 14

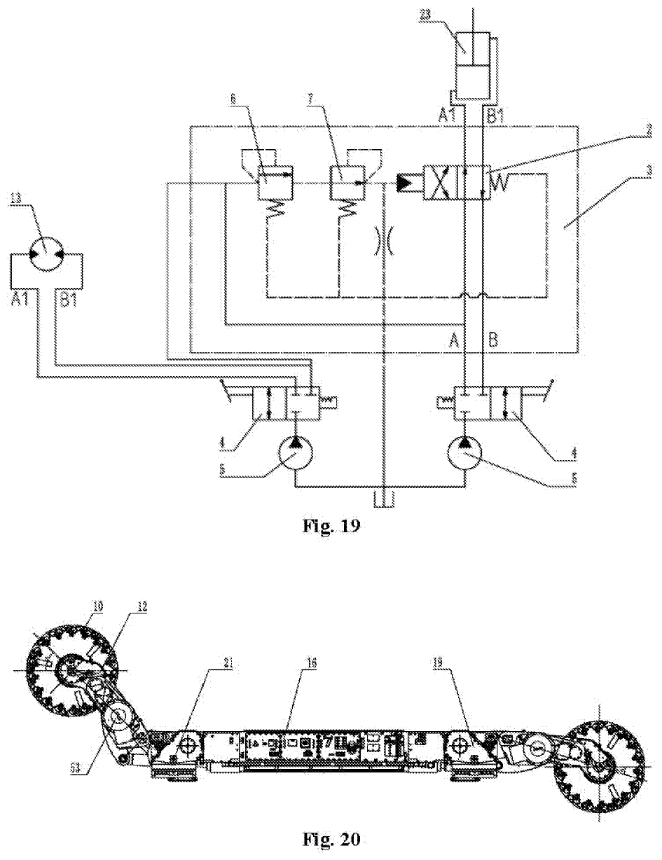

As shown in FIG. 19, Embodiment 14 is an advance and retreat automatic control system based on hydraulic sensing conversion, according to hardness of a material which needs to be dug, a normal digging pressure value of a digging motor 6 is determined, and a pressure value of a rocker arm oil cylinder 9 is enabled to be matched with a normal digging pressure value of the digging motor 6, a system pressure value of an advance and retreat automatic device 3 based on hydraulic sensing conversion is set, a maximum pressure value of the digging motor 6 is higher than a maximum pressure value of the rocker arm oil cylinder 9, the pressure value of the rocker arm oil cylinder 9 is set as 28 MPa, and the pressure value of the digging motor 6 is set as 30 MPa, normal digging is performed in a state that the pressure value of the digging motor 6 does not exceed the pressure value of the rocker arm oil cylinder 9, while the digging motor 6 digs an excessive hard material, the pressure value of the digging motor 6 exceeds the maximum pressure value of a hydraulic oil cylinder, namely the pressure value of the digging motor 6 is between 28 MPa and 30 MPa, an oil cylinder advance and retreat automatic mechanism based on hydraulic sensing conversion is capable of enabling the rocker arm oil cylinder 9 to be retreated, while the digging motor 6 digs the excessive hard material, a pressure is improved to exceed the maximum pressure value of the hydraulic oil cylinder and the digging motor 6 is not stopped by overpressure, the hydraulic oil cylinder is instantly retreated, the digging motor 6 does not damage a digging part 13 component because of the digging motor 6 is not stopped by the overpressure due to digging the excessive hard material, sensing the hardness of the dug material is achieved by an oil cylinder automatic telescopic mechanism based on hydraulic sensing conversion and a digging part 13 is protected in advance.

The structure further corresponds to a method: according to the hardness of the material which needs to be dug, the normal digging pressure value of the digging motor 6 is determined, the pressure value of the rocker arm oil cylinder 9 is enabled to be matched with the normal digging pressure value of the digging motor 6, the system pressure value of the advance and retreat automatic device 3 based on the hydraulic sensing conversion is set, the maximum pressure value of the digging motor 6 is enabled to be higher than the maximum pressure value of the rocker arm oil cylinder 9, and the normal digging is enabled to be performed in the state that the pressure value of the digging motor 6 does not exceed the pressure value of the rocker arm oil cylinder 9, while the digging motor 6 digs the excessive hard material, the pressure value of the digging motor 6 exceeds the maximum pressure value of the rocker arm oil cylinder 9, the oil cylinder automatic telescopic mechanism based on the hydraulic sensing conversion is capable of enabling the rocker arm oil cylinder 9 to be retreated, while the digging motor 6 digs the excessive hard material, the pressure is improved to exceed the maximum pressure value of the rocker arm oil cylinder 9 and the digging motor 6 is not stopped by the overpressure, the rocker arm oil cylinder 9 is instantly retreated, the digging motor 16 does not damage the digging part 13 component because of the digging motor 16 is not stopped by the overpressure due to digging the excessive hard material, sensing the hardness of the dug material is achieved by the oil cylinder automatic telescopic mechanism based on the hydraulic sensing conversion and the digging part 13 is protected in advance.

Other is the same as Embodiment 1.

### Embodiment 15

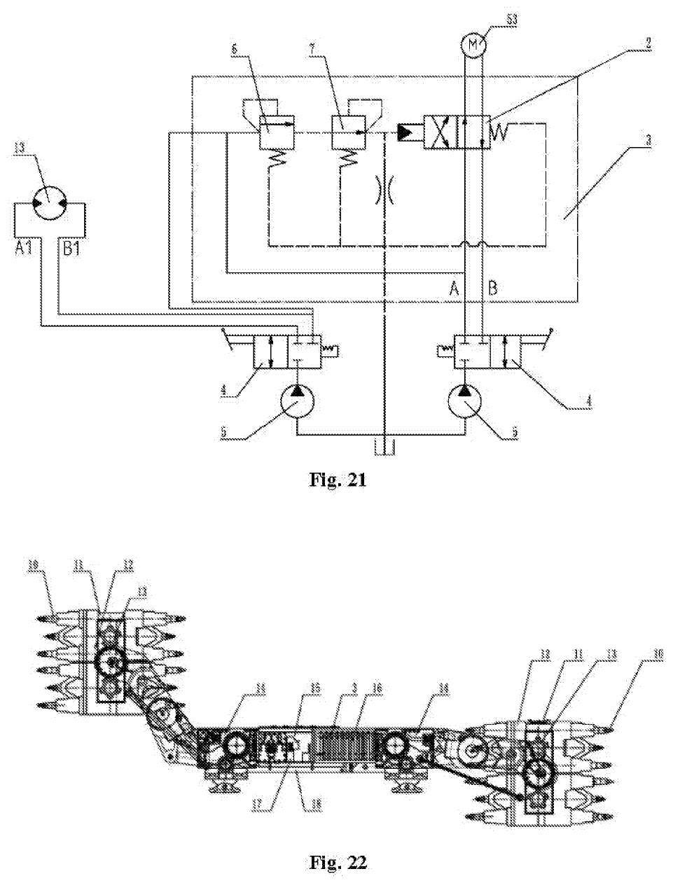

As shown in FIG. 20 and FIG. 21, Embodiment 15 is an advance and retreat automatic control system based on hydraulic sensing conversion, according to hardness of a material which needs to be dug, a normal digging current value of a digging generator 53 is determined, a pressure value of a walking motor 1 is matched with the normal digging current value of the digging generator 53, a system pressure value of an advance and retreat automatic device 3 based on hydraulic sensing conversion is set, while the digging generator 53 digs an excessive hard material, a pressure of the walking motor 1 is instantly increased to exceed a maximum pressure value of the walking motor 1, the advance and retreat automatic device based on the hydraulic sensing conversion 3 is capable of enabling the walking motor 1 to be reversely rotated for retreating, while the digging generator 53 digs the excessive hard material, a current is improved to exceed the maximum pressure value of the walking motor 1 and the digging generator 53 is not stopped by overload, the walking motor 1 is instantly reversely rotated for retreating, and the digging generator 53 does not damage a digging part 13 component because of the digging generator 53 is not stopped by the overload due to digging the excessive hard material, sensing the hardness of the dug material is achieved by the advance and retreat automatic device based on the hydraulic sensing conversion 3 and a digging part 13 is protected in advance.

The structure further corresponds to a method: according to the hardness of the material which needs to be dug, the normal digging current value of the digging generator 53 is determined, the pressure value of the walking motor is enabled to be matched with the normal digging current value of the digging generator 53, the system pressure value of the advance and retreat automatic device abased on the hydraulic sensing conversion is set, a maximum current value of the digging generator 53 is enabled to be higher than the maximum pressure value of the walking motor 1, and normal digging is enabled to be performed in a state that the current value of the digging generator 53 does not exceed the pressure value of the walking motor 1, while the digging generator 53 digs the excessive hard material, the current value of the digging generator 53 exceeds the maximum pressure value of the walking motor 1, the advance and retreat automatic device based on the hydraulic sensing conversion 3 is capable of enabling the walking motor 1 to be reversely rotated for retreating, while the digging generator 53 digs the excessive hard material, the current is improved to exceed the maximum pressure value of the walking motor 1 and the digging generator 53 is not stopped by overload, the walking motor 1 is instantly reversely rotated for retreating, the digging generator 53 does not damage a digging part 13 component because of the digging generator 53 is not stopped by the overload due to digging the excessive hard material, sensing the hardness of the dug material is achieved by the advance and retreat automatic device based on the hydraulic sensing conversion 3 and a digging part 13 is protected in advance.

Other is the same as Embodiment 1.

### Embodiment 16

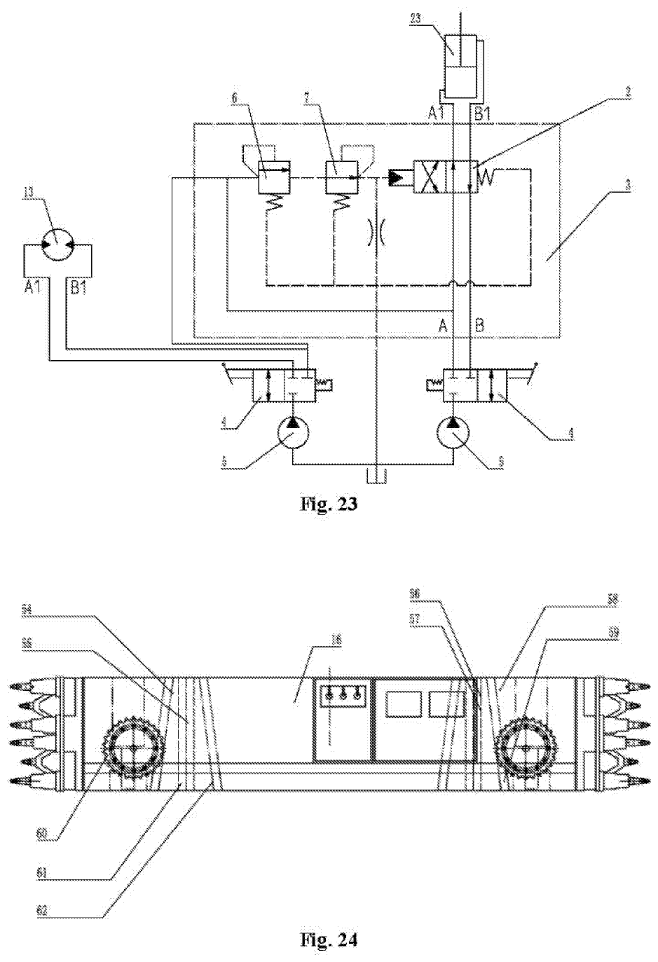

As shown in FIG. 22 and FIG. 23, Embodiment 16 is an advance and retreat automatic control system based on hydraulic sensing conversion, the advance and retreat automatic control system based on the hydraulic sensing conversion includes a machine body 16 and a digging part 13 and the like, the advance and retreat automatic control system based on the hydraulic sensing conversion includes a hydraulic box 17, a hydraulic pump 5 and a pump motor 20 and the like provided on the machine body 16, the hydraulic box 17, the hydraulic pump 5 and the pump motor 20 and the like form a machine body power part 19, two ends of the machine body power part 19 are provided with the digging part 13, the hydraulic pump 5 absorbs liquid which is converted into a power source, the digging part 13 is provided with a digging motor 6, the machine body 16 includes a walking bracket 15 and the like, the walking bracket 15 is provided with a walking motor 1 or a walking generator and the like, the machine body 16 includes a fixed long-arm machine body 18 and the like, while a force of the machine body 16 which is forwards advanced and pushed against a material is greater than a force of a motor 14 and an overpressure occurs, an advance and retreat automatic device based on hydraulic sensing conversion 3 controls the motor 14 to be backwards retreated, the overpressure is released, hydraulic oil is shifted into a forward walking cavity, and the motor 14 is forwards walked, according to hardness of a material which needs to be dug, a normal digging pressure value of the digging motor 6 is determined, a pressure value of a hydraulic oil cylinder is enabled to be matched with the normal digging pressure value of the digging motor 6, a pressure value of an advance and retreat automatic device 3 system based on hydraulic sensing conversion is set, a maximum pressure value of the digging motor 6 is higher than a maximum pressure value of the hydraulic oil cylinder, and normal digging is performed in a state that the pressure value of the digging motor 6 does not exceed the pressure value of the hydraulic oil cylinder, while the digging motor 6 digs an excessive hard material, the pressure value of the digging motor 6 exceeds the maximum pressure value of the hydraulic oil cylinder, an oil cylinder automatic telescopic mechanism based on hydraulic sensing conversion is capable of enabling the hydraulic oil cylinder to be retreated, while the digging motor 6 digs the excessive hard material, a pressure is improved to exceed the maximum pressure value of the hydraulic oil cylinder and the digging motor 6 is not stopped by overpressure, the hydraulic oil cylinder is instantly retreated, the digging motor 6 dose not damage a digging part 13 component because of the digging motor 6 is not stopped by the overpressure due to digging the excessive hard material, sensing the hardness of the dug material is achieved by an oil cylinder automatic telescopic mechanism based on hydraulic sensing conversion and a digging part 13 is protected in advance. The reciprocated impact digging part 13 includes a reciprocated impact box 12 and a digging head 11 and the like, the digging head 11 is installed at two ends of the reciprocated impact box 12, the reciprocated impact box 12 is provided with a crank connecting rod 36, the motor 14 drives the crank connecting rod 36, the crank connecting rod 36 drives the digging head 11 to be reciprocated and impacted, while the digging head 11 is pushed against a material wall so that the digging head 11 may not be reciprocated and impacted, the advance and retreat automatic device based on the hydraulic sensing conversion 3 is capable of enabling the motor 14 to be backwards retreated.

Other is the same as Embodiment 1.

### Embodiment 17

As shown in FIG. 24, Embodiment 17 is an advance and retreat automatic control system based on hydraulic sensing conversion, a machine body 16 is in fixed connection or slide connection and the like with a digging part 13, the machine body 16 includes a digging part fixing structure 61 or a machine body lifting digging part structure 62 and the like, the digging part 13 includes a digging part suspension machine body fixing structure 54 or a digging part suspension machine body lifting structure 55, the digging part suspension machine body fixing structure 54 is buttoned on the digging part fixing structure 61, the machine body lifting digging part structure 62 is cooperated with the digging part suspension machine body lifting structure 55, the digging part fixing structure 61 or the machine body lifting digging part structure 62 is provided with a straight sliding rail 56, and the corresponding digging part suspension machine body fixing structure 54 or digging part suspension machine body lifting structure 55 is provided with a straight sliding chute 57, the straight sliding rail 56 is buttoned with the straight sliding chute 57 so that the digging part 13 is connected with the machine body 16, or the digging part fixing structure 61 and the machine body lifting digging part structure 62 include a small-upper large-lower wedge-shaped sliding rail 59, and the corresponding digging part suspension machine body fixing structure 54 or digging part suspension machine body lifting structure 55 includes a small-upper large-lower wedge-shaped sliding chute 58, the small-upper large-lower wedge-shaped sliding chute 58 is buttoned with the small-upper large-lower wedge-shaped sliding rail 59, under the effect of gravity of the digging part 13, the small-upper large-lower wedge-shaped sliding chute 58 is closely buttoned on the small-upper large-lower wedge-shaped sliding rail 59, the digging part 13 is firmly suspended on the machine body 16 without an auxiliary component so as to increase shock strength, the machine body lifting digging part structure 62 is installed on an end face of the machine body 16 towards a coal wall to be mined or installed on a front part of the machine body 16, the corresponding digging part suspension machine body lifting structure 55 is installed on an end face of the digging part 13 towards the machine body 16 or installed on the front part of the machine body 16, the machine body 16 is provided with an impact part lifting hydraulic cylinder, the digging part suspension machine body lifting structure 55 is buttoned with the machine body lifting digging part structure 62 so that the digging part 13 is suspended on the machine body 16, while the digging part 13 needs to be ascended, the impact part lifting hydraulic cylinder is capable of enabling the digging part suspension machine body lifting structure 55 to be upwards slid to a required height for positioning along the machine body lifting digging part structure 62, while the small-upper large-lower wedge-shaped sliding rail 59 and the small-upper large-lower wedge-shaped sliding chute 58 are used for lifting the digging part 13, the small-upper large-lower wedge-shaped sliding chute 58 is firstly ascended, according to a position which needs to be ascended, an adjusting fixed cushion is installed in the small-upper large-lower wedge-shaped sliding chute 58, the adjusting fixed cushion is between the small-upper large-lower wedge-shaped sliding rail 59 and the small-upper large-lower wedge-shaped sliding chute 58 so as to prevent the small-upper large-lower wedge-shaped sliding chute 58 from being downwards slid so that the digging part 13 is tightly wedged and positioned, and a digging height of the digging part 13 is increased.

Or while the machine body 16 is used for slide connection with the digging part 13, the machine body 16 is slidably buttoned with the digging part 13 and the digging part 13 is lifted with the help of an external force.

Other is the same as Embodiment 1.

### Embodiment 18

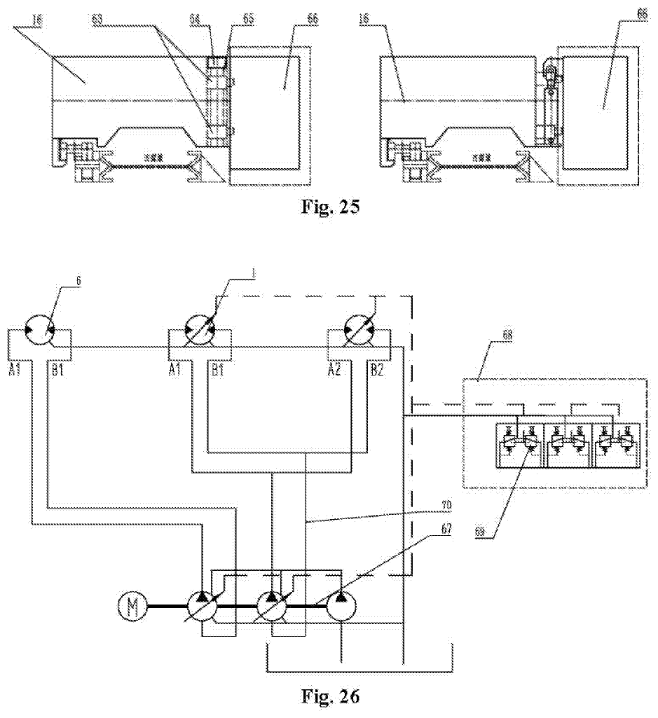

As shown in FIG. 25, Embodiment 18 is an advance and retreat automatic control system based on hydraulic sensing conversion, a machine body lifting digging part structure 62 includes a tension digging part suspension machine body lifting structure pin column 64 hole and a tension digging part suspension machine body lifting structure pin column 64 and the like, while a digging part suspension machine body lifting structure 55 needs to be ascended, the tension digging part suspension machine body lifting structure pin column 64 is placed in the tension digging part suspension machine body lifting structure pin column 64 hole so that a height of the tension digging part suspension machine body lifting structure pin column 64 is consistent with a height of a lifting impact part which needs to be ascended, the tension digging part suspension machine body lifting structure pin column 64 includes a T-type pin column or a straight pin fixed sleeve column, while the T-type pin column is used, a lower part of the T-type pin column is inserted in the tension digging part suspension machine body lifting structure pin column 64 hole, and an upper part of the T-type pin column is buttoned with the digging part suspension machine body lifting structure 55, or while the straight pin fixed sleeve column is used, the straight pin fixed sleeve column includes a sliding rail inserting hole column and a tension digging part fixed sleeve, a lower part of the sliding rail inserting hole column is inserted in the tension digging part suspension machine body lifting structure pin column 64 hole, and an upper part of the sliding rail inserting hole column is buttoned with the tension digging part fixed sleeve so that the exterior of the tension digging part fixed sleeve is buttoned with the digging part suspension machine body lifting structure 55, the tension digging part suspension machine body lifting structure pin column 64 hole supports and fixes the sliding rail inserting hole column, the sliding rail inserting hole column fixes the tension digging fixed sleeve, the digging part suspension machine body lifting structure 55 tightly holds the sliding rail inserting hole column through the tension digging part fixed sleeve, the fixing strength of the digging part 13 and the machine body 16 is increased.

While the machine body 16 is in vertical lifting connection with the digging part 13, the machine body 16 is provided with a locking energy accumulation assistance reciprocated impact part 66 device, the locking energy accumulation assistance reciprocated impact part 66 device includes a gear locker or a pin locker or a tooth row locker or a rope locker or a chain wheel locker or a pressure maintaining locker or a bolt locker or a clamp spring locker or an adjusting fixed cushion locker or a T-type inserting column locker or a tension fixed sleeve locker or a pin rod sleeve locker and the like.

Other is the same as Embodiment 1.

### Embodiment 19

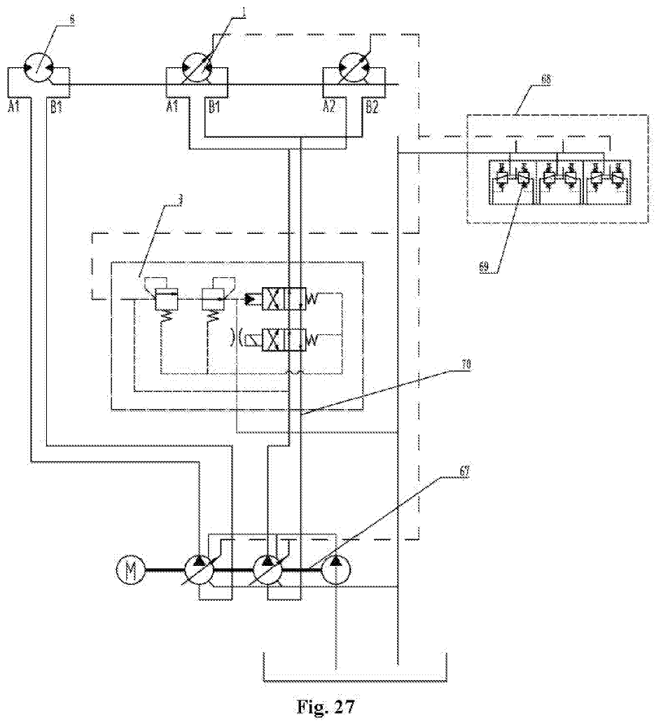

As shown in FIG. 26 and FIG. 27, Embodiment 19 is an advance and retreat automatic control system based on hydraulic sensing conversion, the advance and retreat automatic control system based on the hydraulic sensing conversion includes a hydraulic drive remote control device, the hydraulic drive remote control device includes a closed-type hydraulic drive remote control device, while the closed-type hydraulic drive remote control device is used, the closed-type hydraulic drive remote control device includes a closed-type hydraulic pump 67, a closed-type hydraulic pipe 70, a closed-type pilot valve 69 and a closed-type hydraulic drive remote control operation platform 68, the closed-type hydraulic pipe 70 is connected with the closed-type pilot valve 69 and the closed-type hydraulic pump 67, the closed-type pilot valve 69 is installed on the closed-type hydraulic drive remote control operation platform 68, the closed-type pilot valve 69 includes a closed-type walking pilot valve and a closed-type blanking pilot valve, the closed-type walking pilot valve controls a walking speed of the machine body 16, the closed-type blanking pilot valve controls a blanking amount of the digging part 13, the hydraulic drive remote control device remotely operates a digger through hydraulic drive control, the system is simple and reliable in structure, high in efficiency, and strong in adaptability.

Other is the same as Embodiment 1.

### Embodiment 20

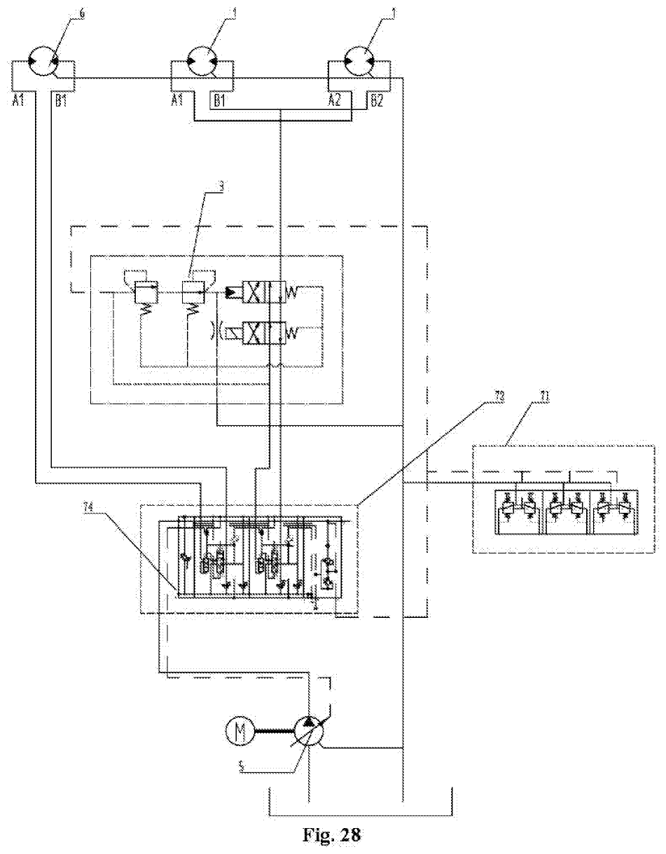

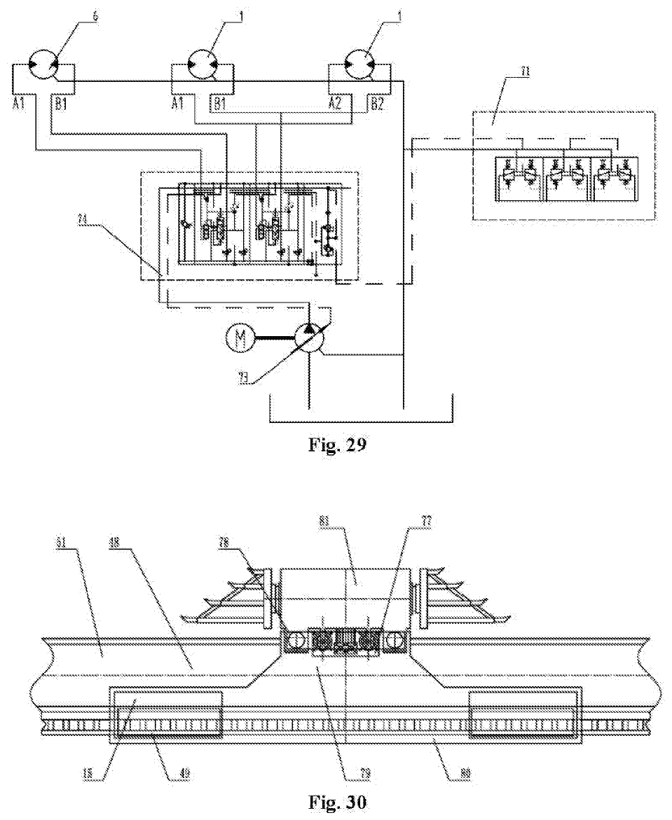

As shown in FIG. 28 and FIG. 29, Embodiment 20 is an advance and retreat automatic control system based on hydraulic sensing conversion, the advance and retreat automatic control system based on the hydraulic sensing conversion includes a hydraulic drive remote control device, the hydraulic drive remote control device includes an opened-type hydraulic drive remote control device 72, while the opened-type hydraulic drive remote control device 72 is used, the opened-type hydraulic drive remote control device 72 includes an opened-type hydraulic pump 73, a load-sensitive control valve 74, an opened-type hydraulic pipe 75, an opened-type pilot valve 76 and an opened-type hydraulic drive remote control operation platform 71, the opened-type hydraulic pipe 75 is connected with the load-sensitive control valve 74, the opened-type pilot valve 76 and the opened-type hydraulic pump 73, the opened-type pilot valve 76 is installed on the opened-type hydraulic drive remote control operation platform 71, the opened-type pilot valve 76 includes an opened-type walking pilot valve and an opened-type blanking pilot valve, the opened-type walking pilot valve controls a walking speed of a machine body 16, the opened-type blanking pilot valve controls a blanking amount of a digging part 13, the hydraulic drive remote control device remotely operates a digger through hydraulic drive control, the system is simple and reliable in structure, high in efficiency, and strong in adaptability.

Other is the same as Embodiment 1.

### Embodiment 21

As shown in FIG. 30, a lower part of a machine body 16 as shown in Embodiment 21 is provided with a scraper conveyer 51, a walking bracket 15 includes a walking bracket bottom plate 49, a machine body power part 19 includes a machine body power part bottom plate 78, a part of the walking bracket bottom plate 49 and the machine body power part bottom plate 78 opposite to the scraper conveyer 51 is provided with a coal passing channel 50, a conveying amount of a dug material is improved, or the walking bracket bottom plate 49 and the machine body power part bottom plate 78 are installed approximate to the scraper conveyer 51, a height of the machine body 16 is reduced for digging a low material, or the machine body 16 is installed in a convex shape, a length of an narrow convex part of the convex shape 79 is approximate to a length of a digging part box body 81, the length of the digging part box body 81 is shortened to reduce a weight of a digging part 13, a wide long part of the convex shape 80 is greater than the narrow convex part of the convex shape 79, a support force and anti-shock gravity of the machine body 16 to the digging part 13 are increased, and a lateral tension force of the digging part 13 to the machine body 16 is relatively reduced, a width of a convex part of the convex shape is approximate to a width of the scraper conveyer 51, a lower part of the convex part of the convex shape is installed approximate to the scraper conveyer 51 or the coal passing channel 50 is installed between the lower part of the convex part of the convex shape and the scraper conveyer 51, the material dug by the digging part 13 is conveyed out of a digging area through convex hollow space by the scraper conveyer 51.

Other is the same as Embodiment 1.

### Embodiment 22

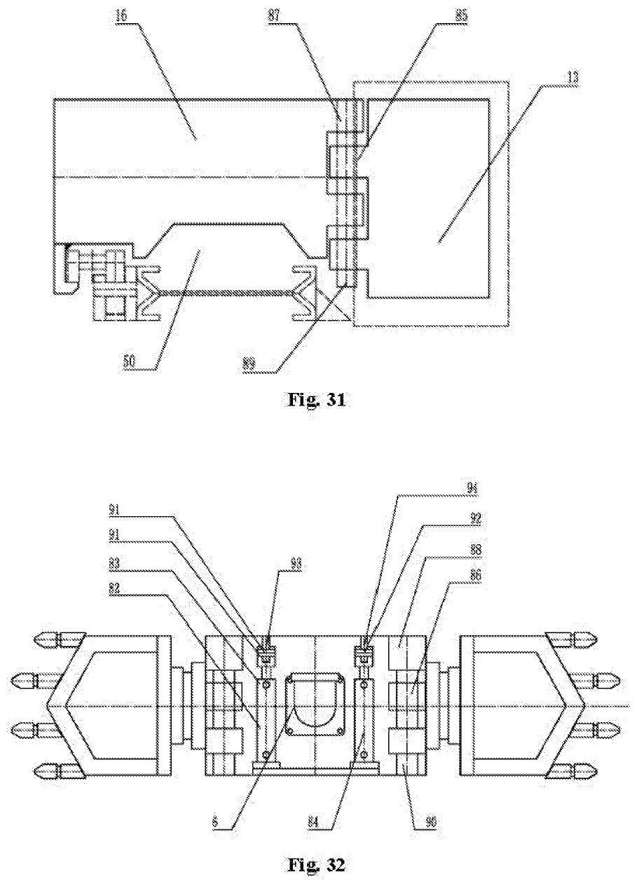

As shown in FIG. 31 and FIG. 32, a machine body 16 as shown in Embodiment 22 further includes a digging part lifting hydraulic cylinder 82, the digging part lifting hydraulic cylinder 82 includes a digging part single-lifting hydraulic cylinder 82 or a digging part double-lifting hydraulic cylinder 82, the digging part double-lifting hydraulic cylinder 82 includes a digging part left-lifting hydraulic cylinder 83 and a digging part right-lifting hydraulic cylinder 84, the digging part left-lifting hydraulic cylinder 83 and the digging part right-lifting hydraulic cylinder 84 are installed at two sides of a digging motor 6, the machine body 16 is provided with a suspension digging part left guiding component 85 and a suspension digging part right guiding component 86, a digging part 13 is provided with a suspension machine body left guiding component 87 and a suspension machine body right guiding component 88 matched with it, the machine body 16 further includes a digging part left-lifting guiding rod 89 and a digging part right-lifting guiding rod 90, the digging part left-lifting guiding rod 89 passes through and is connected with the suspension digging part left guiding component 85 and the suspension machine body left guiding component 87, the digging part right-lifting guiding rod 90 passes through and is connected with the suspension digging part right guiding component 86 and the suspension machine body right guiding component 88, the digging part left-lifting hydraulic cylinder 83 and the digging part right-lifting hydraulic cylinder 84 are installed between the suspension digging part left guiding component 85 and the suspension digging part right guiding component 86, the digging part left-lifting hydraulic cylinder 83 is installed approximate to the suspension digging part left guiding component 85, the digging part right-lifting hydraulic cylinder 84 is installed approximate to the suspension digging part right guiding component 86.

One end of the digging part left-lifting hydraulic cylinder 83 is fixed on the machine body 16 or fixed on the digging part 13, while one end of the digging part left-lifting hydraulic cylinder 83 is fixed on the machine body 16, the lifting digging part 13 is provided with a left connection lifting oil cylinder lug 93, while one end of the digging part right-lifting hydraulic cylinder 84 is fixed on the machine body 16, the lifting digging part 13 is provided with a right connection lifting oil cylinder lug 94, the digging part left-lifting hydraulic cylinder 83 includes a connection left-lifting oil cylinder pin 91, the digging part right-lifting hydraulic cylinder 84 includes a connection right-lifting oil cylinder pin 92, the connection left-lifting oil cylinder 33 pin passes through and is connected with the digging part left-lifting hydraulic cylinder 83 and the left connection lifting oil cylinder lug 93, the connection right-lifting oil cylinder pin 92 passes through and is connected with the digging part right-lifting hydraulic cylinder 84 and the right connection lifting oil cylinder lug 94, while the digging part 13 needs to be ascended, the digging part 13 is simultaneously lifted by the digging part left-lifting hydraulic cylinder 83 and the digging part right-lifting hydraulic cylinder 84, the suspension machine body left guiding component 87 is upwards slid along the digging part left-lifting guiding rod 89, the suspension machine body right guiding component 88 is upwards slid along the digging part right-lifting guiding rod 90, the digging part left-lifting guiding rod 89 and the digging part right-lifting guiding rod 90 are capable of fixing a left-right direction of the digging part 13, the digging part left-lifting hydraulic cylinder 83 and the digging part right-lifting hydraulic cylinder 84 support the lifted digging part 13, as to ensure the stable lifting of the digging part 13, a digging height of the digging part 13 is increased or a dinting mining depth of the digging part 13 is increased.

Other is the same as Embodiment 1.

### Embodiment 23

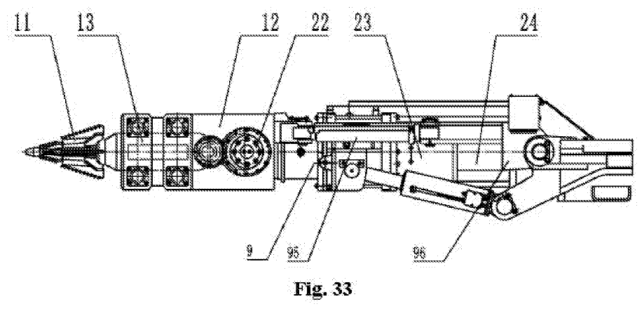

As shown in FIG. 33, an advance and retreat automatic control system based on hydraulic sensing conversion as shown in Embodiment 23 includes a machine body 16 and a digging part 13, the machine body 16 includes a fixed long-arm machine body 18 or a telescopic arm machine body 25 or a directly connected digging part machine body 96, the telescopic arm machine body 25 includes a telescopic rocker arm 24, an oil cylinder includes a rocker arm telescopic oil cylinder 23 and/or a rocker arm swing oil cylinder 95, an advance and retreat automatic device based on hydraulic sensing conversion 3 is installed on the telescopic rocker arm 24 or installed on the machine body 16 or installed on the digging part 13, a front end of the telescopic rocker arm 24 is provided with a digging head 11, the advance and retreat automatic device based on the hydraulic sensing conversion 3 controls a rocker arm oil cylinder 9 or controls a walking motor 1, while a force of the telescopic rocker arm 24 stretched out and pushed against a material is greater than a stretching force of the rocker arm oil cylinder 9 and an overpressure occurs, the advance and retreat automatic device based on the hydraulic sensing conversion 3 is capable of enabling hydraulic oil to be flowed into a backward retreat cavity of the rocker arm oil cylinder 9, and enabling the telescopic rocker arm 24 to be backwards retreated, at this moment, the overpressure in a forward advance cavity is released, the hydraulic oil is shifted into the forward advance cavity and the telescopic rocker arm 24 is forwards stretched out, or while a force of the machine body 16 which is forwards advanced and pushed against the material is greater than a force of the walking motor 1 and the overpressure occurs, the advance and retreat automatic device based on the hydraulic sensing conversion 3 controls the walking motor 1 to be backwards retreated, the overpressure is released, and the walking motor 1 is forwards walked, or according to hardness of the material which needs to be dug, a normal digging pressure value of a digging motor 6 is determined, a pressure value of the rocker arm oil cylinder 9 is enabled to be matched with the normal digging pressure value of the digging motor 6, while the digging head 11 is leftwards and rightwards swung for digging an excessive hard material, and a pressure value of the digging motor 6 is in overpressure, an oil cylinder automatic telescopic mechanism based on hydraulic sensing conversion is capable of enabling the rocker arm swing oil cylinder 95 to be retreated, the digging motor 6 does not damage a digging part 13 component because of the digging motor 6 is not stopped by the overpressure due to digging the excessive hard material, sensing the hardness of the dug material is achieved by the oil cylinder automatic telescopic mechanism based on the hydraulic sensing conversion in forward and backward impact, leftward and rightward sawing, and upward and downward material digging processes of the digging head 11, and the digging part 13, the rocker arm oil cylinder 9, and the walking motor 1 and the like are protected in advance.

Other is the same as Embodiment 1.

What is claimed is:

1. An advance and retreat automatic control method based on hydraulic sensing conversion, comprising:
one, installing an advance and retreat automatic device based on hydraulic sensing conversion, enabling the advance and retreat automatic device based on the hydraulic sensing conversion to be formed by a hydraulic operated directional valve, or enabling the advance and retreat automatic device based on the hydraulic sensing conversion to be formed by a sequence valve and a hydraulic operated directional valve, or enabling the advance and retreat automatic device based on the hydraulic sensing conversion to be formed by a sequence valve, a pressure reducing valve and a hydraulic operated directional valve, or enabling the advance and retreat automatic device based on the hydraulic sensing conversion to be formed by an energy accumulator, a sequence valve and a hydraulic operated directional valve, or enabling the advance and retreat automatic device based on the hydraulic sensing conversion to be formed by an energy accumulator, a sequence valve, a pressure reducing valve and a hydraulic operated directional valve;
two, enabling the advance and retreat automatic device based on the hydraulic sensing conversion to be cooperated with a digging motor and a walking motor so as to form a motor advance and retreat automatic mechanism based on hydraulic sensing conversion, or enabling the advance and retreat automatic device based on the hydraulic sensing conversion to be cooperated with a digging motor and a rocker arm oil cylinder so as to form an oil cylinder automatic telescopic mechanism based on reciprocated impact hydraulic sensing conversion, or enabling the advance and retreat automatic device based on the hydraulic sensing conversion to be cooperated with a digging oil cylinder and a rocker arm oil cylinder so as to form an oil cylinder automatic telescopic mechanism based on digging hydraulic sensing conversion, enabling a pressure value of the motor advance and retreat automatic device based on the hydraulic sensing conversion is enabled to be less than a pressure value of an overpressure state of the digging motor, or enabling a pressure value of the oil cylinder automatic telescopic device based on the reciprocated impact hydraulic sensing conversion to be less than a pressure value of the overpressure state of the digging motor, or enabling a pressure value of the oil cylinder automatic telescopic device based on the digging hydraulic sensing conversion to be less than a pressure value of an overpressure state of the digging oil cylinder;
three, while the digging motor encounters with an overlarge resistance, a pressure of the digging motor is instantly increased to exceed a setting pressure value, hydraulic oil enters the hydraulic operated directional valve, a valve rod is pushed so that the walking motor is reversely rotated, an ultrahigh pressure state of the digging motor is released to restore a normal pressure value for the reciprocated impact, and the valve rod of the hydraulic operated directional valve is reset, so the walking motor is forwards rotated for advancing; or while the digging motor encounters with an overlarge resistance, a pressure of the digging motor is instantly increased to exceed a setting pressure value, hydraulic oil enters the hydraulic operated directional valve through the sequence valve, the valve rod is pushed so that the walking motor is reversely rotated, an ultrahigh pressure state of the digging motor is released to restore a normal pressure value for the reciprocated impact, the walking motor is forwards rotated for advancing, and the sequence valve is cooperated with the hydraulic operated directional valve to ensure precision of retreat and advance restoration of the walking motor; or while the digging motor encounters with an overlarge resistance, a pressure of the digging motor is instantly increased to exceed a setting pressure value, the hydraulic oil enters the hydraulic operated directional valve through the sequence valve and the pressure reducing valve, the valve rod is pushed so that hydraulic oil enters a retreat cavity of the rocker arm oil cylinder, and a cylinder rod is retreated, an ultrahigh pressure state of the digging motor is released to restore a normal pressure value for the reciprocated impact, the sequence valve and the pressure reducing valve are cooperated with the hydraulic operated directional valve so as to ensure precision of retreat and advance restoration of the rocker arm oil cylinder, and ensure that retreat speed and distance of the cylinder rod are adjustable while the rocker arm oil cylinder encounters with an overpressure state; or while the digging motor encounters with an overlarge resistance, a pressure of the digging motor is instantly increased to exceed a setting pressure value, the hydraulic oil enters the hydraulic operated directional valve through the energy accumulator, the sequence valve and the pressure reducing valve, the valve rod is pushed so that the hydraulic oil enables the walking motor to be reversely rotated, an ultrahigh state of the digging motor is enabled to be released, the walking motor is enabled to be forwards rotated for advancing, and the energy accumulator, the sequence valve and the pressure reducing valve are enabled to be cooperated with the hydraulic operated directional valve so as to ensure speed and precision of retreat and advance restoration of the rocker arm oil cylinder, and ensure that retreat speed and distance of the cylinder rod are adjustable while the rocker arm oil cylinder encounters with an overpressure state.

2. The advance and retreat automatic control method based on the hydraulic sensing conversion as claimed in claim 1, wherein according to hardness of a material which needs to be dug, determining a normal digging pressure value of the digging motor, and adjusting a pressure value of the walking motor so that it is matched with the normal digging pressure value of the digging motor, while a pressure value of the digging motor needs to be improved when the hard material is impacted, improving a pressure value of an advance and retreat automatic device system based on hydraulic sensing conversion so that it is matched with the pressure value of the digging motor, while the digging motor digs an excessive hard material, a pressure of the digging motor exceeds a setting pressure value, the motor advance and retreat automatic mechanism based on the hydraulic sensing conversion is capable of enabling the walking motor to be reversely rotated for retreating, the digging motor dose not damage a digging part component because of the digging motor is not stopped by the overpressure due to digging the excessive hard material, and sensing the hardness of the dug material is achieved by the motor advance and retreat automatic mechanism based on the hydraulic sensing conversion and a digging part is protected in advance; or according to the hardness of the material which needs to be dug, determining the normal digging pressure value of the digging motor, enabling the pressure value of the rocker arm oil cylinder to be matched with the normal digging pressure value of the digging motor, while the digging motor digs the excessive hard material, the pressure value of the digging motor is instantly increased to exceed the setting pressure value, the oil cylinder automatic telescopic mechanism based on the hydraulic sensing conversion is capable of enabling the rocker arm oil cylinder to be retreated, the digging motor dose not damage a digging part component because of the digging motor is not stopped by the overpressure due to digging the excessive hard material, sensing the hardness of the dug material is achieved by the oil cylinder automatic telescopic mechanism based on the hydraulic sensing conversion and the digging part is protected in advance; or according to the hardness of the material which needs to be dug, determining a normal digging current value of a digging generator, enabling a pressure value of the walking motor to be matched with a normal digging current value of the digging generator, while the digging generator digs the excessive hard material, a pressure of the walking motor is instantly increased to exceed the setting pressure value, the advance and retreat automatic device based on the hydraulic sensing conversion is capable of enabling the walking motor to be reversely rotated for retreating, while the digging generator digs the excessive hard material, a current is improved and the digging generator is not stopped by overload, the walking motor is instantly reversely rotated for retreating, and the digging generator dose not damage a digging part component because of the digging generator is not stopped by the overload due to digging the excessive hard material, sensing the hardness of the dug material is achieved by the advance and retreat automatic device based on the hydraulic sensing conversion and the digging part is protected in advance.

3. An advance and retreat automatic control system based on hydraulic sensing conversion for implementing the advance and retreat automatic control method based on the hydraulic sensing conversion as claimed in claim 1, wherein the advance and retreat automatic control system based on the hydraulic sensing conversion comprises an advance and retreat automatic device based on hydraulic sensing conversion, the advance and retreat automatic control system based on the hydraulic sensing conversion further comprises a motor, an oil cylinder and/or an electric generator, the advance and retreat automatic device based on the hydraulic sensing conversion comprises a hydraulic operated directional valve, or the advance and retreat automatic device based on the hydraulic sensing conversion comprises a sequence valve and a hydraulic operated directional valve, or the advance and retreat automatic device based on the hydraulic sensing conversion comprises a sequence valve, a pressure reducing valve and a hydraulic operated directional valve, or the advance and retreat automatic device based on the hydraulic sensing conversion comprises an energy accumulator, a sequence valve and a hydraulic operated directional valve, or the advance and retreat automatic device based on the hydraulic sensing conversion comprises an energy accumulator, a sequence valve, a pressure reducing valve and a hydraulic operated directional valve, the motor comprises a digging motor and/or a walking motor, the oil cylinder comprises a rocker arm oil cylinder and/or a digging oil cylinder, the advance and retreat automatic device based on the hydraulic sensing conversion is cooperated with a digging motor and a walking motor so as to form a motor advance and retreat automatic mechanism based on hydraulic sensing conversion, or the advance and retreat automatic device based on the hydraulic sensing conversion is cooperated with the digging motor and the rocker arm oil cylinder so as to form an oil cylinder automatic telescopic mechanism based on reciprocated impact hydraulic sensing conversion, or the advance and retreat automatic device based on the hydraulic sensing conversion is cooperated with a digging oil cylinder and a rocker arm oil cylinder so as to form an oil cylinder automatic telescopic mechanism based on digging hydraulic sensing conversion, a pressure of the motor advance and retreat automatic device based on the hydraulic sensing conversion is less than a pressure value of an overpressure state of the digging motor, or a pressure of the oil cylinder automatic telescopic device based on the reciprocated impact hydraulic sensing conversion is less than the pressure value of the overpressure state of the digging motor, or a pressure of the oil cylinder automatic telescopic device based on the digging hydraulic sensing conversion is less than the pressure value of the overpressure state of the digging oil cylinder, while the digging motor encounters with an overlarge resistance, the pressure of the digging motor is instantly increased to exceed a setting pressure value, hydraulic oil enters the hydraulic operated directional valve, a valve rod is pushed so that the walking motor is reversely rotated, an ultrahigh pressure state of the digging motor is released to restore the normal pressure value for the reciprocated impact, and the valve rod of the hydraulic operated directional valve is reset, so the walking motor is forwards rotated for advancing, or while the digging motor encounters with the overlarge resistance, the pressure of the digging motor is instantly increased to exceed the setting pressure value, the hydraulic oil enters the hydraulic operated directional valve through the sequence valve, the valve rod is pushed so that the walking motor is reversely rotated for retreating, the ultrahigh pressure state of the digging motor is released to restore the normal pressure value for the reciprocated impact, the walking motor is forwards rotated for advancing, and the sequence valve is cooperated with the hydraulic operated directional valve to ensure the precision of retreat and advance restoration of the walking motor, or while the digging motor encounters with the overlarge resistance, the pressure of the digging motor is instantly increased to exceed the setting pressure value, the hydraulic oil enters the hydraulic operated directional valve through the sequence valve and the pressure reducing valve, the valve rod is pushed so that the hydraulic oil enters the retreat cavity of the rocker arm oil cylinder, and the cylinder rod is retreated, the ultrahigh pressure state of the digging motor is released to restore the normal pressure value for the reciprocated impact, the sequence valve and the pressure reducing valve are cooperated with the hydraulic operated directional valve so as to ensure the precision of retreat and advance restoration of the rocker arm oil cylinder, and ensure that the retreat speed and distance of the cylinder rod are adjustable while the rocker arm oil cylinder encounters with the overpressure state, or while the digging motor encounters with the overlarge resistance, the pressure of the digging motor is instantly increased to exceed the setting pressure value, the hydraulic oil enters the hydraulic operated directional valve through the energy accumulator, the sequence valve and the pressure reducing valve, the valve rod is pushed so that the hydraulic oil enables the walking motor to be reversely rotated, the ultrahigh state of the digging motor is released so that the walking motor is forwards rotated for advancing, and the energy accumulator, the sequence valve and the pressure reducing valve are cooperated with the hydraulic operated directional valve so as to ensure the speed and the precision of retreat and advance restoration of the rocker arm oil cylinder, and ensure that the retreat speed and distance of the cylinder rod are adjustable while the rocker arm oil cylinder encounters with the overpressure state.

4. The advance and retreat automatic control system based on the hydraulic sensing conversion as claimed in claim 3, wherein according to the hardness of the material which needs to be dug, determining a normal digging pressure value of the digging motor, and adjusting a pressure value of the walking motor so that it is matched with the normal digging pressure value of the digging motor, while the pressure value of the digging motor needs to be improved when the hard material is impacted, improving a pressure value of the advance and retreat automatic device system based on the hydraulic sensing conversion so that it is matched with a pressure value of the digging motor, while the digging motor digs the excessive hard material, and the pressure of the digging motor exceeds the setting pressure value, the motor advance and retreat automatic mechanism based on the hydraulic sensing conversion is capable of enabling the walking motor to be reversely rotated for retreating, the digging motor dose not damage a digging part component because of the digging motor is not stopped by the overpressure due to digging the excessive hard material, sensing the hardness of the dug material is achieved by the motor advance and retreat automatic mechanism based on the hydraulic sensing conversion and a digging part is protected in advance; or according to the hardness of the material which needs to be dug, determining a normal digging pressure value of the digging motor, enabling a pressure value of the rocker arm oil cylinder to be matched with the normal digging pressure value of the digging motor, while the digging motor digs the excessive hard material, the pressure value of the digging motor is instantly increased to exceed the setting pressure value, the oil cylinder automatic telescopic mechanism based on the hydraulic sensing conversion is capable of enabling the rocker arm oil cylinder to be retreated, the digging motor dose not damage a digging part component because of the digging motor is not stopped by the overpressure due to digging the excessive hard material, sensing the hardness of the dug material is achieved by the oil cylinder automatic telescopic mechanism based on the hydraulic sensing conversion and a digging part is protected in advance, or according to the hardness of the material which needs to be dug, determining a normal digging current value of the digging generator, enabling a pressure value of the walking motor to be matched with the normal digging current value of the digging generator, while the digging generator digs the excessive hard material, the pressure of the walking motor is instantly increased to exceed the setting pressure value, the advance and retreat automatic device based on the hydraulic sensing conversion is capable of enabling the walking motor to be reversely rotated for retreating, while the digging motor digs the excessive hard material, a current is improved and the digging generator is not stopped by overload, the walking motor is instantly reversely rotated for retreating, and the digging generator dose not damage a digging part component because of the digging generator is not stopped by the overload due to digging the excessive hard material, sensing the hardness of the dug material is achieved by the advance and retreat automatic device based on the hydraulic sensing conversion and a digging part is protected in advance.

5. The advance and retreat automatic control system based on the hydraulic sensing conversion as claimed in claim 3, wherein the advance and retreat automatic control system based on the hydraulic sensing conversion comprises a machine body and the digging part, the advance and retreat automatic control system based on the hydraulic sensing conversion comprises a hydraulic box, a hydraulic pump and a pump motor disposed on the machine body, the hydraulic box, the hydraulic pump and the pump motor form a machine body power part, one end or two ends of the machine body are provided with the digging part, the hydraulic pump absorbs liquid which is converted into a power source, the digging part comprises the digging motor or the digging oil cylinder or the digging generator, the machine body comprises a walking bracket, the walking bracket is provided with the walking motor or a walking generator, the machine body comprises a fixed long-arm machine body or a telescopic arm machine body or a directly connected digging part machine body, the telescopic arm machine body comprises a telescopic rocker arm, the telescopic rocker arm comprises the rocker arm oil cylinder, the rocker arm oil cylinder comprises a rocker arm telescopic oil cylinder and/or a rocker arm swing oil cylinder, the advance and retreat automatic device based on the hydraulic sensing conversion is installed on the telescopic rocker arm or installed on the machine body or installed on the digging part, a front end of the telescopic rocker arm is provided with a digging head, the advance and retreat automatic device based on the hydraulic sensing conversion controls the rocker arm oil cylinder or controls the walking motor, while a force of the telescopic rocker arm stretched out and pushed against the material is greater than a stretching force of the rocker arm oil cylinder and the overpressure occurs, the advance and retreat automatic device based on the hydraulic sensing conversion is capable of enabling the hydraulic oil to be flowed into a backward retreat cavity of the rocker arm oil cylinder, and enabling the telescopic rocker arm to be backwards retreated, at this moment, the overpressure in a forward advance cavity is released, the hydraulic oil is shifted into the forward advance cavity and the telescopic rocker arm is forwards stretched out, or while a force of the machine body which is forwards advanced and pushed against the material is greater than a force of the walking motor and the overpressure occurs, the advance and retreat automatic device based on the hydraulic sensing conversion controls the walking motor to be backwards retreated, the overpressure is released, and the walking motor is forwards advanced, or according to the hardness of the material which needs to be dug, determining the normal digging pressure value of the digging motor, enabling the pressure value of the rocker arm oil cylinder to be matched with the normal digging pressure value of the digging motor, while the digging motor digs the excessive hard material and the pressure value of the digging motor is in the overpressure, the oil cylinder automatic telescopic mechanism based on the hydraulic sensing conversion is capable of enabling the rocker arm swing oil cylinder to be retreated, the digging motor dose not damage a digging part component because of the digging motor is not stopped by the overpressure due to digging the excessive hard material, sensing the hardness of the dug material is achieved by the oil cylinder automatic telescopic mechanism based on the hydraulic sensing conversion and the digging part is protected in advance.

6. The advance and, retreat automatic control system based on the hydraulic sensing conversion as claimed in claim 3, wherein the advance and retreat automatic device based on the hydraulic sensing conversion comprises a pressurizer or the energy accumulator, while the pressurizer is used, the pressurizer is installed on a pump output pipeline or installed on a motor oil inlet pipeline or installed on a hydraulic cylinder oil inlet pipeline or installed on the advance and retreat automatic device based on the hydraulic sensing conversion, or while the energy accumulator is used, the energy accumulator is installed on a pump output pipeline or installed on a motor oil inlet pipeline or installed on a hydraulic cylinder oil inlet pipeline or installed on the advance and retreat automatic device based on the hydraulic sensing conversion.

7. The advance and retreat automatic control system based on the hydraulic sensing conversion as claimed in, claim 5, wherein the machine body is in fixed connection or slide connection with the digging part, the machine body comprises a machine body fixed digging part structure or a machine body lifting digging part structure, the digging part comprises a digging part suspension machine body fixing structure or a digging part suspension machine body lifting structure, the machine body fixed digging part structure is buttoned on the digging part suspension machine body fixing structure, the machine body lifting digging part structure is cooperated with the digging part suspension machine body lifting structure, the machine body fixed digging part structure or the machine body lifting digging part structure is provided with a straight sliding rail, and the corresponding digging part suspension machine body fixing structure or digging part suspension machine body lifting structure is provided with a straight sliding chute, the straight sliding rail is buttoned with the straight sliding chute so that the digging part is connected with the machine body;
or the machine body fixed digging part structure or the machine body lifting digging part structure comprises a small-upper large-lower wedge-shaped sliding rail and the corresponding digging part suspension machine body fixing structure or digging part suspension machine body lifting structure comprises a small-upper large-lower wedge-shaped sliding chute, the small-upper large-lower wedge-shaped sliding chute is buttoned with the small-upper large-lower wedge-shaped sliding rail, under an effect of gravity of the digging part, the small-upper large-lower wedge-shaped sliding chute is closely buttoned on the small-upper large-lower wedge-shaped sliding rail, the digging part is firmly suspended on the machine body without an auxiliary component so as to increase shock strength, or the machine body lifting digging part structure is installed on an end face of the machine body towards a coal wall to be mined or installed on a front part of the machine body, the corresponding digging part suspension machine body lifting structure is installed on an end face of the digging part towards the machine body or installed on the front part of the machine body, or while the slide connection of the machine body and the digging part is used, the machine body is slidably buttoned with the digging part and the digging part is lifted by an external force, the machine body lifting digging part structure comprises a tension digging part suspension machine body lifting structure pin column hole and a tension digging part suspension machine body lifting structure pin column, the tension digging part suspension machine body lifting structure pin column comprises a T-type pin column or a straight pin fixed sleeve column, while the T-type pin column is used, a lower part of the T-type pin column is inserted in the tension digging part suspension machine body lifting structure pin column hole, and an upper part of the T-type pin column is buttoned with the digging part suspension machine body lifting structure, or while the straight pin fixed sleeve column is used, the straight pin fixed sleeve column comprises a sliding rail inserting hole column and a tension digging part fixed sleeve, a lower part of the sliding rail inserting hole column is inserted in the tension digging part suspension machine body lifting structure pin column hole, and an upper part of the sliding rail inserting hole column is buttoned with the tension digging part fixed sleeve so that an exterior of the tension digging part fixed sleeve is buttoned with the digging part suspension machine body lifting structure, the tension digging part suspension machine body lifting structure pin column hole supports and fixes the sliding rail inserting hole column, the sliding rail inserting hole column fixes the tension digging fixed sleeve, the digging part suspension machine body lifting structure tightly holds the sliding rail inserting hole column through the tension digging part fixed sleeve, the fixing strength of the digging part and the machine body is increased, or the machine body is provided with a lifting digging part hydraulic cylinder, the digging part suspension machine body lifting structure is buttoned with the machine body lifting digging part structure so that the digging part is suspended on the machine body, while the digging part needs to be ascended, the lifting digging part hydraulic cylinder is capable of enabling the digging part suspension machine body lifting structure to be upwards slid to a required height for positioning along the machine body lifting digging part structure, or while the small-upper large-lower wedge-shaped sliding rail and the small-upper large-lower wedge-shaped sliding chute are used for lifting the digging part, the small-upper large-lower wedge-shaped sliding chute is firstly ascended, according to a position which needs to be ascended, an adjusting fixed cushion is installed in the small-upper large-lower wedge-shaped sliding chute, the adjusting fixed cushion is disposed between the small-upper large-lower wedge-shaped sliding rail and the small-upper large-lower wedge-shaped sliding chute so as to prevent the small-upper large-lower wedge-shaped sliding chute from being downwards slid so that the digging part is tightly wedged and positioned, and a digging height of the digging part is increased.

8. The advance and retreat automatic control system based on the hydraulic sensing conversion as claimed in claim 1, wherein while the machine body is connected with the digging part through vertical lifting, the advance and retreat automatic control system based on the hydraulic sensing conversion comprises a digging part locking device provided on the machine body, the digging part locking device comprises a gear locker or a pin locker or a tooth row locker or a chain wheel locker or a pressure maintaining locker or a bolt locker or a clamp spring locker or an adjusting fixed cushion locker or a T-type inserting column locker or a tension fixed sleeve locker or a pin rod sleeve locker or a hydraulic pressure balance valve locker.

9. The advance and retreat automatic control system based on the hydraulic sensing conversion as claimed in claim 5, wherein an end part of the walking bracket is provided with a walking hinge lug, the fixed long-arm machine body comprises a rocker arm, the rocker arm comprises a rocker arm hinge lug and a support arm, the rocker arm further comprises a hinge support reciprocated impact box inner cylinder and/or a hinge support reciprocated impact box outer cylinder, while the hinge support reciprocated impact box inner cylinder is installed on the rocker arm, a reciprocated impact box comprises a reciprocated impact box connecting outer cylinder, while the hinge support reciprocated impact box outer cylinder is installed on the rocker arm, the reciprocated impact box comprises a reciprocated impact box connecting inner cylinder, the rocker arm hinge lug is installed at a rear end of the support arm and hinged with the walking hinge lug, the hinge support reciprocated impact box outer cylinder and/or the hinge support reciprocated impact box inner cylinder is installed at a front end of the support arm, the reciprocated impact box connecting inner cylinder is installed in the reciprocated impact box connecting outer cylinder for stop sleeve connection or the reciprocated impact box connecting inner cylinder is installed in the reciprocated impact box connecting outer cylinder for rotation sleeve connection, one end, towards the reciprocated impact box, of the hinge support reciprocated impact box inner cylinder or the hinge support reciprocated impact box outer cylinder is provided with a connecting reciprocated impact box component, the connecting reciprocated impact box component is connected with the reciprocated impact box or integrated with the reciprocated impact box, the support arm is provided with a reciprocated impact support arm hydraulic pipe cavity, a reciprocated impact hydraulic pipe passes through the reciprocated impact support arm hydraulic pipe cavity and is connected with the digging motor, the digging motor is installed in the hinge support reciprocated impact box inner cylinder and connected with a crank connecting rod or the digging motor is installed outside the hinge support reciprocated impact box inner cylinder and connected with a crank connecting rod, the rocker arm is provided with the telescopic oil cylinder and the swing oil cylinder, one end of the telescopic oil cylinder and one end of the swing oil cylinder are hinged with the rocker arm, and the other end of the telescopic oil cylinder and the swing oil cylinder is hinged with the machine body, a hydraulic pipe is installed in the rocker arm or installed outside the rocker arm, the telescopic oil cylinder is installed in the reciprocated impact box connecting inner cylinder or installed outside the reciprocated impact box connecting inner cylinder, the reciprocated impact box connecting inner cylinder is pushed to be stretched relative to the reciprocated impact box connecting outer cylinder.

10. The advance and retreat automatic control system based on the hydraulic sensing conversion as claimed in claim 5, wherein the hydraulic box comprises a hydraulic box body, the hydraulic box body comprises a liquid inlet and a liquid outlet, the hydraulic box comprises one or more liquid separating plates installed between the liquid inlet and the liquid outlet, one end of each of one or more liquid separating plates is seal-connected with the hydraulic box body at a liquid outlet end, and the other end of the each of one or more liquid separating plates is provided with a separating plate liquid flowing channel or a separating plate through hole, liquid is forced to be flowed in the hydraulic box body within a maximum distance through installation of the liquid separating plate, a cavity at two sides of the each of one or more liquid separating plates is internally provided with a cooling water pipe and/or a cooling water cavity, the cooling water pipe is in U-shaped connection arrangement so as to form a U-shaped cooling water pipe row, a U-shaped bottom of the U-shaped cooling water pipe row is installed towards a bottom plate of the hydraulic box body, or while the hydraulic box body is internally provided with the hydraulic pipe, a U-shaped bottom of the U-shaped cooling water pipe row is upward, a U-shaped port is buttoned at an upper part of the hydraulic pipe so as to disassemble and maintain conveniently, the hydraulic box body is internally provided with a U-shaped cooling water pipe row fixing component, the U-shaped cooling water pipe row fixing component is installed at the bottom of the hydraulic box body and/or installed on the one or more liquid separating plates, the liquid inlet is provided with a liquid return filter, the liquid enters the hydraulic box body from the liquid inlet through the liquid return filter or the liquid directly enters the hydraulic box body and is flowed along the one or more liquid separating plates under blocking of the one or more liquid separating plates and flowed to the liquid outlet through the separating plate liquid flowing channel or the separating plate through hole, the each of the one or more liquid separating plates prevents the liquid from being directly flowed from the liquid inlet to the liquid outlet, the liquid is forced to be circularly flowed in the hydraulic box body, the cooling water pipe and/or the cooling water cavity is used for cooling liquid while the liquid is flowed from one end to the other end, the U-shaped cooling water pipe row increases a cooling area and improves cooling stability performance.

11. The advance and retreat automatic control system based on the hydraulic sensing conversion as claimed in claim 5, wherein the advance and retreat automatic control system based on the hydraulic sensing conversion comprises a scraper conveyer provided on a lower part of the machine body, the walking bracket comprises a walking bracket bottom plate, the machine body power part comprises a machine body power part bottom plate, a part of the walking bracket bottom plate and the machine body power part bottom plate opposite to the scraper conveyer is provided with a coal passing channel, a conveying amount of the dug material is improved, or the walking bracket bottom plate and the machine body power part bottom plate are installed approximate to the scraper conveyer, a height of the machine body is reduced for digging a low material, or the machine body is installed in a convex shape, a length of an narrow convex part of the convex shape is approximate to a length of the digging part box body, the length of the digging part box body is shortened to reduce a weight of the digging part, a wide long part of the convex shape is greater than the narrow convex part of the convex shape, a support force and anti-shock gravity of the machine body to the digging part are increased, and a lateral tension force of the digging part to the machine body is relatively reduced, a width of a convex part of the convex shape is approximate to a width of the scraper conveyer, a lower part of the convex part of the convex shape is installed approximate to the scraper conveyer or the coal passing channel is installed between the lower part of the convex part of convex shape and the scraper conveyer, the material dug by the digging part is conveyed out of a digging area through convex hollow space by the scraper conveyer.

12. The advance and retreat automatic control system based on the hydraulic sensing conversion as claimed in claim 5, wherein the advance and retreat automatic control system based on the hydraulic sensing conversion comprises a water spray cooling component provided on the rocker arm or the reciprocated impact box or the machine body, the water spray cooling component comprises a water spray cooling pipe and/or a sprayer, the water spray cooling pipe passes through the reciprocated impact support arm hydraulic pipe cavity and is connected with the cooling water pipe or the water spray cooling pipe is connected with the digging part or the water spray cooling pipe is installed on the machine body.

13. The advance and retreat automatic control system based on the hydraulic sensing conversion as claimed in claim 5, wherein the machine body comprises a control operation platform, the control operation platform comprises a machine body control operation platform and/or a remote control operation platform, while the machine body control operation platform is used, the machine body control operation platform and the hydraulic pump are leftwards and rightwards installed or forwards and backwards installed, or while the remote control operation platform is used, the remote control operation platform is set as an electric drive remote control operation platform or set as a hydraulic drive remote control operation platform, while the control operation platform and the hydraulic pump are leftwards and rightwards installed, a reinforced rib plate is installed between the control operation platform and the hydraulic pump, the reinforced rib plate is capable of reinforcing anti-shock and tensile strength of the machine body, the advance and retreat automatic control system based on the hydraulic sensing conversion comprises a hydraulic drive remote control device, the hydraulic drive remote control device comprises a closed-type hydraulic drive remote control device or an opened-type hydraulic drive remote control device, while the closed-type hydraulic drive remote control device is used, the closed-type hydraulic drive remote control device comprises a closed-type hydraulic pump, a hydraulic pipe, a pressurizing pump, a pilot valve and a closed-type hydraulic drive remote control operation platform, the hydraulic pipe is connected with the pilot valve and the closed-type hydraulic pump, the pressurizing pump and the pilot valve are installed on the closed-type hydraulic drive remote control operation platform, the pilot valve comprises a walking pilot valve and a blanking pilot valve, the walking pilot valve controls a walking speed of the machine body, the blanking pilot valve controls a blanking amount of the digging part, or while the opened-type hydraulic drive remote control device is used, the opened-type hydraulic drive remote control device comprises an opened-type volume adjustable hydraulic pump, a load-sensitive multi-path control valve, a hydraulic pipe, a pressurizing pump, a pilot valve and an opened-type hydraulic drive remote control operation platform, the hydraulic pipe is connected with the load-sensitive multi-path control valve, the pilot valve and the hydraulic pump, the pressurizing pump and the pilot valve are installed on the opened-type hydraulic drive remote control operation platform, the pilot valve comprises a walking pilot valve and a blanking pilot valve, the walking pilot valve controls the walking speed of the machine body, the blanking pilot valve controls the blanking amount of the digging part, the hydraulic drive remote control device remotely operates a digger through the hydraulic drive control, which is simple in structure, safe and reliable, high in efficiency, and strong in adaptability.

14. The advance and retreat automatic control system based on the hydraulic sensing conversion as claimed in claim 3, wherein the sequence valve and the hydraulic operated directional valve are used in sub-assembly or used by forming a sequence conversion cartridge valve, or the sequence valve, the pressure reducing valve and the hydraulic operated directional valve are used in sub-assembly or used by forming a pressure reducing direction reversing cartridge valve, or the energy accumulator, the sequence valve, the pressure reducing valve and the hydraulic operated directional valve are used in sub-assembly or used by forming an energy accumulation sequence pressure reducing direction reversing cartridge valve.

15. The advance and retreat automatic control system based on the hydraulic sensing conversion as claimed in claim 3, wherein the machine body further comprises a digging part lifting hydraulic cylinder, the digging part lifting hydraulic cylinder comprises a digging part single-lifting hydraulic cylinder or a digging part double-lifting hydraulic cylinder, while the digging part double-lifting hydraulic cylinder is used, the digging part comprises the digging motor, the digging part double-lifting hydraulic cylinder comprises a digging part left-lifting hydraulic cylinder and a digging part right-lifting hydraulic cylinder, the digging part left-lifting hydraulic cylinder and the digging part right-lifting hydraulic cylinder are installed at two sides of the digging motor, the machine body is provided with a suspension digging part left guiding component and a suspension digging part right guiding component, the digging part is provided with a suspension machine body left guiding component and a suspension machine body right guiding component matched with it, the machine body further comprises a digging part left-lifting guiding rod and a digging part right-lifting guiding rod, the digging part left-lifting guiding rod passes through and is connected with the suspension digging part left guiding component and the suspension machine body left guiding component, the digging part right-lifting guiding rod passes through and is connected with the suspension digging part right guiding component and the suspension machine body right guiding component, the digging part left-lifting hydraulic cylinder and the digging part right-lifting hydraulic cylinder are installed between the suspension digging part left guiding component and the suspension digging part right guiding component, the digging part left-lifting hydraulic cylinder is installed approximate to the suspension digging part left guiding component, the digging part right-lifting hydraulic cylinder is installed approximate to the suspension digging part right guiding component, one end of the digging part left-lifting hydraulic cylinder is fixed on the machine body or fixed on the digging part, while one end of the digging part left-lifting hydraulic cylinder is fixed on the machine body, the lifting digging part is provided with a left connection lifting oil cylinder lug, while one end of the digging part right-lifting hydraulic cylinder is fixed on the machine body, the lifting digging part is provided with a right connection lifting oil cylinder lug, the digging part left-lifting hydraulic cylinder comprises a connection left-lifting oil cylinder pin, the digging part right-lifting hydraulic cylinder comprises a connection right-lifting oil cylinder pin, the connection left-lifting oil cylinder pin passes through and is connected with the digging part left-lifting hydraulic cylinder and the left connection lifting oil cylinder lug, the connection right-lifting oil cylinder pin passes through and is connected with the digging part right-lifting hydraulic cylinder and the right connection lifting oil cylinder lug, while the digging part needs to be ascended, the digging part is simultaneously lifted by the digging part left-lifting hydraulic cylinder and the digging part right-lifting hydraulic cylinder, the suspension machine body left guiding component is upwards slid along the digging part left-lifting guiding rod, the suspension machine body right guiding component is upwards slid along the digging part right-lifting guiding rod, the digging part left-lifting guiding rod and the digging part right-lifting guiding rod are capable of fixing a left-right direction of the slid digging part, the digging part left-lifting hydraulic cylinder and the digging part right-lifting hydraulic cylinder support the lifted digging part, as to ensure the stable lifting of the digging part, a digging height of the digging part is increased or a dinting mining depth of the digging part is increased.
